(19) United States
(12) Patent Application Publication
(10) Pub. No.: US 2008/0081131 A1
(43) Pub. Date: Apr. 3, 2008

(54) INSULATING FILM FORMATION PROCESS

(75) Inventor: Makoto MURAMATSU, Shizuoka (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/865,152

(22) Filed: Oct. 1, 2007

(30) Foreign Application Priority Data
Sep. 29, 2006 (JP) 2006-269803

(51) Int. Cl. B05D 3/06; C08F 30/08

(52) U.S. Cl. 427/596; 526/282

(57) ABSTRACT

A production method of an insulating film includes (1) a process of applying, onto a substrate, a film forming composition comprising a compound having a cage structure to form a film and then drying the film; and (2) a process of irradiating the film with an electron beam or an electromagnetic wave having a wavelength greater than 200 nm.

### BACKGROUND OF THE INVENTION

1. Field of the Invention

The present invention relates to a production process of an insulating film, an insulating film and an electronic device. More specifically, the invention pertains to a process capable of producing an insulating film for use in electronic devices and the like and good in film properties such as dielectric constant and mechanical strength; an insulating film available by the process, and an electronic device having the insulating film.

2. Description of the Related Art

In recent years, with the progress of high integration, multifunction and high performance in the field of electronic materials, circuit resistance and condenser capacity between interconnects have increased and have caused an increase in electric power consumption and delay time. Particularly, the increase in delay time becomes a large factor for reducing the signal speed of devices and generating crosstalk, Reduction of parasitic resistance and parasitic capacity am therefore required in order to reduce this delay time, thereby attaining speed-up of devices. As one of the concrete measures for reducing is parasitic capacity, an attempt has been made to cover the periphery of an interconnect with a low dielectric interlayer insulating film. The interlayer insulating film is expected to have excellent heat resistance in a thin film formation step when a printed circuit board is manufactured or in post steps such as chip connection and pin attachment and also chemical resistance sufficient to withstand the wet process. In addition, a low resistance Cu interconnect has been introduced in recent years instead of an A1 interconnect, and along with this, CMP (chemical mechanical polishing) has been employed commonly for planarization. Accordingly, an insulating film having high mechanical strength and capable of withstanding this CMP step is required.

An insulating film having a cage structure and an insulating film having a cage structure and using a pore forming aid are known to have a low dielectric constant and excellent mechanical strength (International Publication No. WO2003/060979). In the development field of insulating films, there is a demand for either reduction of dielectric constant and further improvement of mechanical strength.

Insulating films are required to have resistance to heat treatment that is employed in repetition in a metallization step after film formation. When a film undergoes a great change in thereof owing to the heat treatment after metallization, the stress transfers to the interconnect and causes disconnection thereof. It is therefore important that a drastic change in the internal stress in an insulating film does not occur by the heat treatment.

### SUMMARY OF THE INVENTION

The invention relates to an insulating film capable of overcoming the above-described problems. More specifically, the invention pertains to an insulting film for use in electronic devices and the like and good in film properties such as dielectric constant, mechanical strength and heat resistance; and a formation process of the insulating film. Moreover, the invention relates to electronic devices having the insulating film. An “insulating film” is also referred to as a “dielectric film” or a “dielectric insulating film”, and these terms are not substantially distinguished.

It has been found that the above-described problems can be overcome by the following constitutions <1> to <12>.

<1> A production method of an insulating film, comprising:

(1) a process of applying, onto a substrate, a film forming composition comprising a compound having a cage structure to form a film and then drying the film; and

(2) a process of irradiating at film with an electron beam or an electromagnetic wave having a wavelength greater 200 nm.

<2> The production method as described in <1>,

wherein the film forming composition comprises a compound having photosensitivity to an electron beam or an electromagnetic wave having a wavelength greater than 200 nm.

<3> The production method as described in <1>,

wherein the compound having a cage structure has a functional group having photosensitivity to an electron beam or an electromagnetic wave having a wavelength greater than 200 nm.

<4> The production method as described in <1>,

wherein the compound having a cage structure is a polymer of a monomer having a cage structure.

<5> The production method as described in <4>,

wherein the polymer is a polymer of a monomer having a cage structure and a carbon-carbon double bond or carbon-carbon triple bond.

<6> The production method as described in <1>,

wherein the cage structure is selected from the group consisting of adamantane, biadamantane, diamantane, triamantane, and tetramantane.

<7> The production method as described in <4>,

wherein the monomer having a cage structure is selected from the group consisting of compounds represented by the following formulas (I) to (VI):

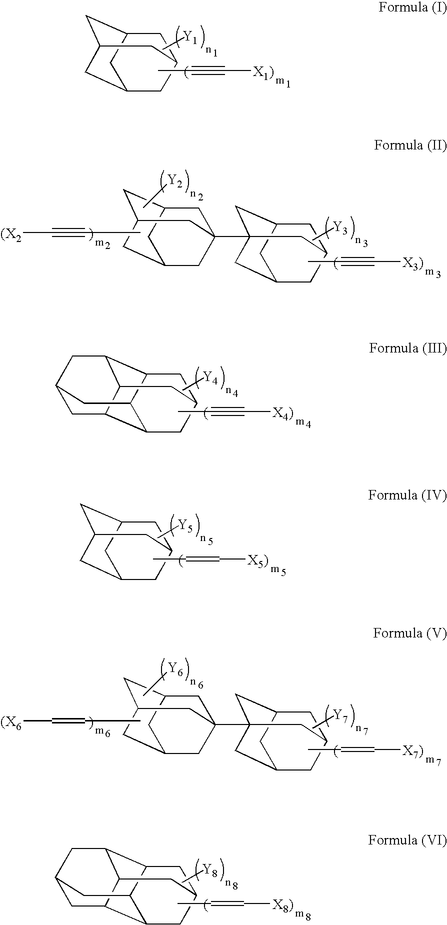

wherein X₁ to X₈ each independently represents a hydrogen atom, an alkyl group, an alkenyl group, an alkynyl group, an aryl group, a silyl group, an acyl group, an alkoxycarbonyl group or a carbamoyl group,

Y₁ to Y₈ each independently represents a halogen atom, an alkyl group, an aryl group or a silyl group,

m₁ and m₅ each independently represents an integer of from 1 to 16,

n₁ and n₅ each independently represents an integer of from 0 to 15,

m₂, m₃, m₆ and m₇ each independently represents an integer of from 1 to 15,

n₂, n₃, n₆ and n₇ each independently represents a integer of from 0 to 14,

m₄ and m₈ each independently represents an integer of from 1 to 20, and

n₄ and n₈ each independently represents an integer of from 0 to 19,

<8> The production method as described in <1>,

wherein the compound having a cage structure comprises m pieces of RSi(O_{0.5})₃ units,

wherein m represents an integer of from 8 to 16,

each of Rs represents a non-hydrolyzable group, with the proviso that each of at least two Rs represents a group having a vinyl group or ethynyl group, and

each of the units is linked with other units by sharing the oxygen atoms to form the cage structure.

<9> The production method as described in <4>,

wherein the monomer having a cage structure is a compound comprising m pieces of RSi(O_{0.5})₃ units,

wherein m represents an integer of from 8 to 16,

each of Rs represents a non-hydrolyzable group with the proviso that each of at least two Rs represents a group having a vinyl group or ethynyl group, and

each of the units is linked with other units by sharing the oxygen atoms to form the cage structure.

<10> An insulating film produced by the production method as described in <1>.

<11> The insulating film as described in <10>,

wherein a rate of an internal stress change of the insulating film caused by heat treatment at 400° C. for 30 minutes is 10% or less.

<12> An electronic device comprising the insulating film as described in <10>.

### DETAILED DESCRIPTION OF THE INVENTION

The present invention will hereinafter be described specifically.

The invention makes it possible to provide an insulating film having a low dielectric constant and excellent mechanical strength by using a low dielectric compound having a cage structure and exposing the compound to an electron beam or electromagnetic wave having a wavelength greater than 200 nm to form a denser crosslinked structure. The formation of the denser crosslinked structure leads to a reduction in the amount of functional groups which will be released due to the heat treatment after film formation and also a reduction in linear expansion coefficient, making it possible to decrease the separation of an interconnect from an insulating film. An insulating film having high reliability can therefore be provided by the invention.

### <Compound Having Cage Structute>

The term “cage structure” as used herein means a molecule whose space is defined by a plurality of rings formed by covalent-bonded atoms and a point existing within the space cannot depart from the space without passing through these rings. For example, an adamantane structure may be considered as the cage structure. Contrary to this, a cyclic structure having a single crosslink such as norbornane (bicyco[2,2,1]heptane) cannot bed considered as the cage structure because the ring of the single-crosslinked cyclic compound does not define the space of the compound.

The cage structure in the invention may have one or more substituents. Examples of the substituents include halogen atoms (fluorine, chlorine, bromine and iodine), linear, branched or cyclic C₁₋₁₀ alkyl groups (such as methyl, t-butyl, cyclopentyl and cyclohexyl), C₂₋₁₀ alkenyl groups (such as vinyl and propenyl), C₂₋₂₀ alkynyl groups (such as ethynyl and phenylethynyl), C₆₋₂₀ aryl groups (such as phenyl, 1-naphthyl and 2-naphthyl), C₂₋₁₀ acyl groups (such as benzoyl), C₆₋₂₀ aryloxy groups (such as phenoxy), C₆₋₂₀ arylsulfonyl groups (such a phenylsulfonyl), nitro group, cyano group, and silyl groups (such as triethoxysilyl, methyldiethoxysilyl and trivinylsilyl). Of these, preferred are fluorine atom, bromine atom, linear, branched or cyclic C₁₋₅ alkyl groups, C₂₋₅ alkenyl groups, C₂₋₅ alkynyl groups, and silyl group. These substituents may be replaced by another substituent.

The cage structure in the invention is preferably from monovalent to tetravalent, more preferably from divalent to tetravalent. At this time, a group to be bonded to the cage structure may be a monovalent or polyvalent substituent or divalent or higher valent linking group.

The term “compound having a cage structure” as used herein means either a low molecular compound or high molecular compound, with an oligomer or polymer being preferred.

The cage structure in the invention may be incorporated in a polymer main chain as a monovalent or polyvalent pendant group. Preferred examples of the polymer main chain to which the compound having a cage structure (which compound will hereinafter be called “cage compound” simply) is bonded include conjugated unsaturated bond chains such as poly(arylene), poly(arylene ether), poly(ether) and polyacetylene, and polyethylene. Of these, poly(arylene ether) and polyacetylene are more preferred because of better heat resistance.

In the invention, it is also preferred that the cage structure constitutes a portion of the polymer main chain. When the cage structure constitutes a portion of the polymer main chain, the polymer chain is broken by the removal of the cage structure from the polymer. In this state, the cage structures may be singly bonded to each other directly or may be bonded by an appropriate divalent or higher valent linking group. Example of the linking group include —C(R¹)(R²)—, —C(R³)═C(R⁴)—, —C≡C—, arylene group, —CO—, —O— —SO₂—, —N(R⁵)—, and —Si(R⁶)(R⁷)—, and combinations thereof. In these groups, R¹ to R⁷ each independently represents a hydrogen atom or an alkyl, alkenyl, alkynyl, aryl or alkoxy group. These linking groups may be substituted by a substituent and the above-described substituents are preferably employed here.

Of these, —C(R¹)(R²)—, —CH═CH—, —C≡C—, arylene group, —O— and —Si(R⁶)(R⁷)—, and combinations thereof are more preferred, with —CH═CH—, —C≡C—, —O— and —Si(R⁶)(R⁷)—, and combinations thereof being especially preferred.

The “compound having a cage structure” to be used in the invention may contain, in the molecular thereof, one or more than one cage structures.

The compound having a cage structure according the invention may be either a low molecular compound or a high molecular compound (such as polymer), but a polymer of a monomer having a cage structure is preferred. When the compound having a cage structure is a polymer, it has a mass average molecular weight of preferably from 1,000 to 500,000, more preferably from 5,000 to 200,000, especially preferably from 10,000 to 100,000. The polymer having a cage structure may be contained in an insulating film forming coating solution as a resin composition having a molecular weight distribution. When the compound having a cage structure is a low molecular compound, it has a molecular weight of preferably from 150 to 3,000, more preferably from 200 to 2,000, especially preferably from 220 to 1,000.

The compound having cage structure according to the invention is preferably a polymer of a monomer having both a cage structure and a polymerizable carbon-carbon double bond or carbon-carbon triple bond. The compound having a cage structure according to the invention is preferably a compound having, as the cage structure, adamantane, biadamantane, diamantane, triamantane or tetramantane. It is more preferably a polymer of a compound having a molecular structure shown below or a compound containing, as a portion thereof, a molecular structure shown below.

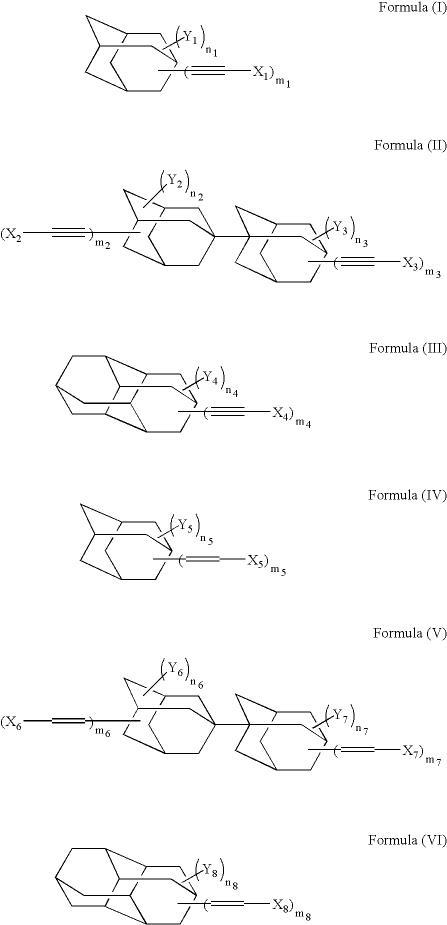

In the formulas (I) to (VI),

X₁ (s) to X₈(s) each independently represents a hydrogen atom, an alkyl group (preferably, a C₁₋₁₀ one), an alkenyl group (preferably C₂₋₁₀ one), an alkynyl group (preferably, C₂₋₁₀ one), an aryl group (preferably, C₆₋₂₀ one), a silyl group (preferably, C₀₋₂₀ one), an acyl group (preferably, C₂₋₁₀ acyl one), an alkoxycarbonyl group (preferably C₂₋₁₀ one), or a carbamoyl group (preferably, C₁₋₂₀ one), of which hydrogen atom, C₁₋₁₀ alkyl group, C₆₋₂₀ aryl group, C₀₋₂₀ silyl group, C₂₋₁₀ acyl group, C₂₋₁₀ alkoxycarbonyl group, or C₁₋₂₀ carbamoyl group is preferred; hydrogen atom or C₆₋₂₀ aryl group is more preferred; and hydrogen atom is especially preferred.

Y₁(s) to Y₈(s) each independently represents an alkyl group (preferably C₁₋₁₀ one), an aryl group (preferably, C₆₋₂₀ one), or a silyl group (preferably, C₀₋₂₀ one), of which an optionally substituted C₁₋₁₀ alkyl group or C₆₋₂₀ aryl group is more preferred and an alkyl (methyl or the like) group is especially preferred.

X₁(s) to X₈(s) and Y₁(s) to Y₈(s) may each be substituted by another substituent.

In the above formulas,

m₁ and m₅ each independently stands for an integer from 1 to 16, preferably from 1 to 4, more preferably from 1 to 3, especially preferably 2;

n₁ and n₅ each independently stands for an integer from 0 to 15; preferably from 0 to 4, more preferably 0 or 1, especially preferably 0;

m₂, m₃, m₆ and m₇ each independently stands for an integer from 1 to 15; preferably from 1 to 4, more preferably 1 to 3, especially preferably 2;

n₂, n₃, n₆ and n₇ each independently stands for an integer from 0 to 14; preferably from 0 to 4, more preferably 0 or 1, especially preferably 0;

m₄ and m₈ each independently stands for an integer from 1 to 20; preferably from 1 to 4, more preferably from 1 to 3, especially preferably 2; and

n₄ and n₈ each independently stands for an integer from 0 to 19, preferably from 0 to 4, more preferably 0 or 1, especially preferably 0.

The monomer having a cage structure according to the invention is preferably a compound represented by the above described formula (II), (III), (V) or (VI), more preferably a compound represented by the formula (II) or (III) especially preferably a compound represented by the formula (III).

Two or more of the compounds having a cage structure according to the invention may be used in combination, or two or more of the monomers having a cage structure according to the invention may be copolymerized.

Examples of the compound having a cage structure according to the invention include polybenzoxazoles described in Japanese Patent Laid Open Nos. 1999-322929, 2003-12802, and 2004-18593, quinoline resins described in Japanese Patent Laid-Open No. 2001-2899, polyaryl resins described in International Patent Publication Nos. 2003-530464, 2004-535497, 2004-504424, 2004-504455, 2005-501131, 2005-516382, 2005-514479, and 2005-522528, Japanese Patent Laid-Open No. 2000-100808 and U.S. Pat. No. 6,509,415, polyadamantanes described in Japanese Patent Laid-Open Nos. 1999-214382, 2001-332542, 2003-252982, 2003-292878, 2004-2787, 2004-67877 and 2004-59444, and polyimides described in Japanese Patent Laid-Open Nos. 2003-252992 and 2004-26850.

Specific examples of the monomer having a cage structure and usable in the invention include, but are not limited to, the following ones. The invention can be appliedted to compounds having, as a portion thereof, the following structure.

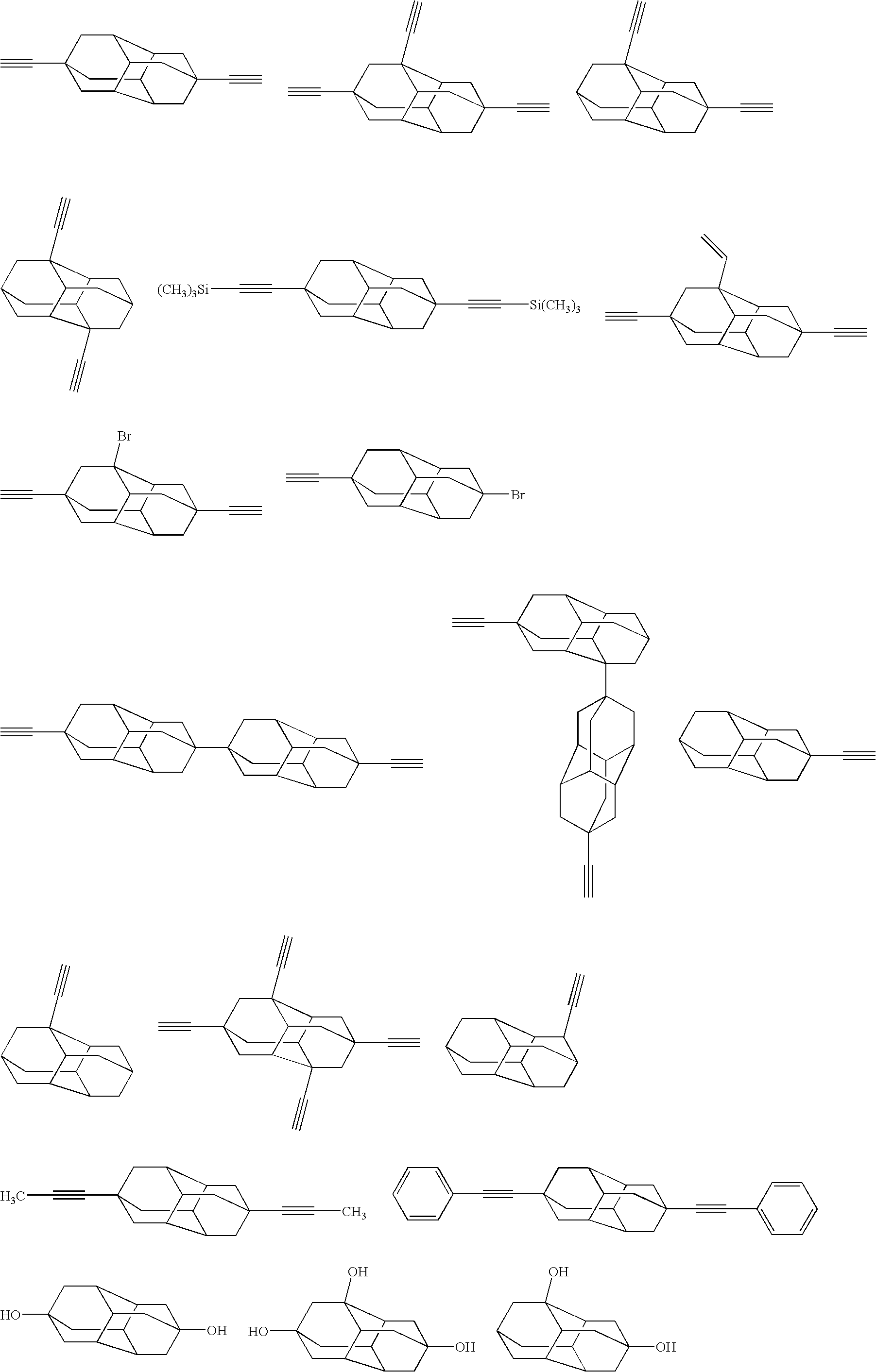

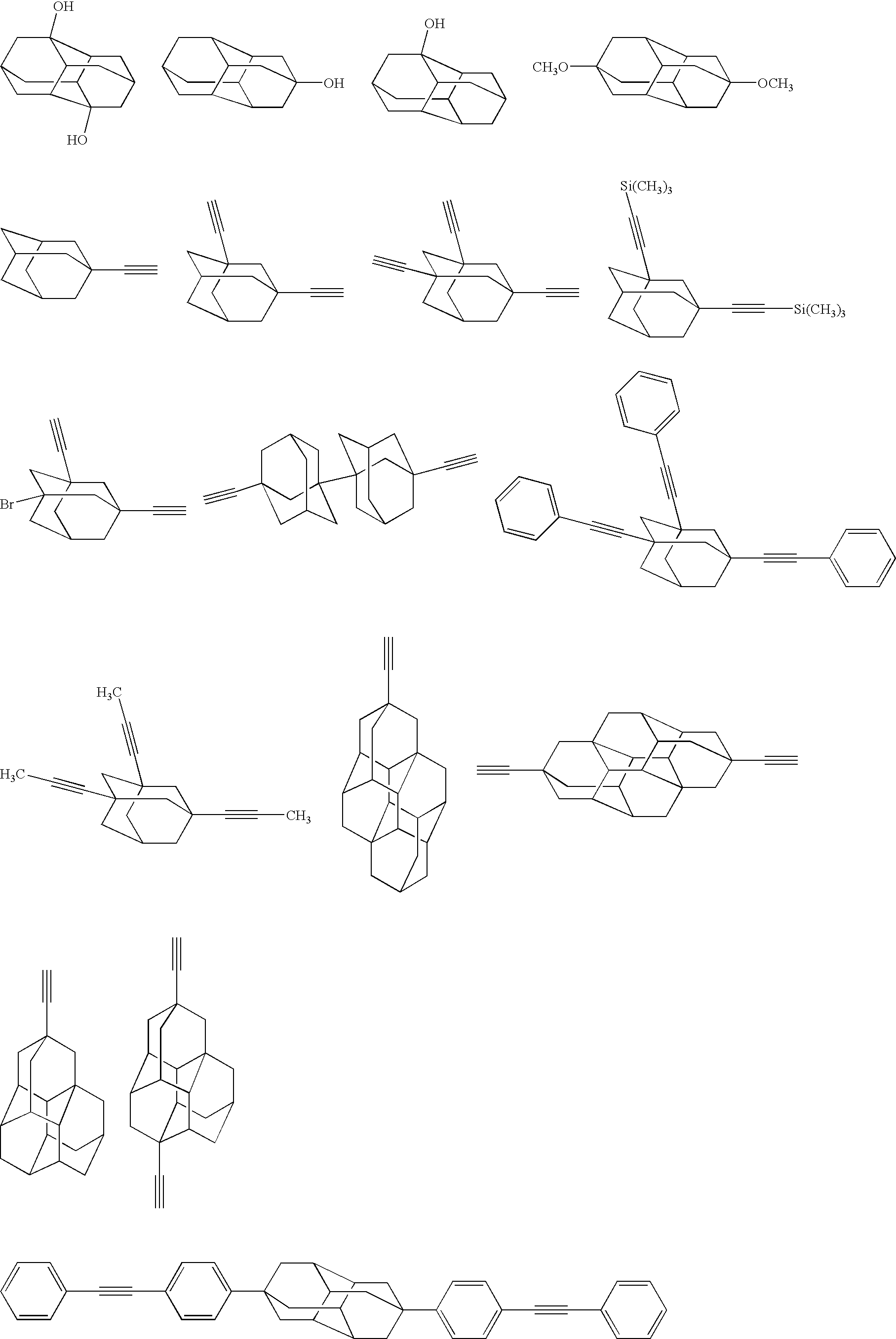

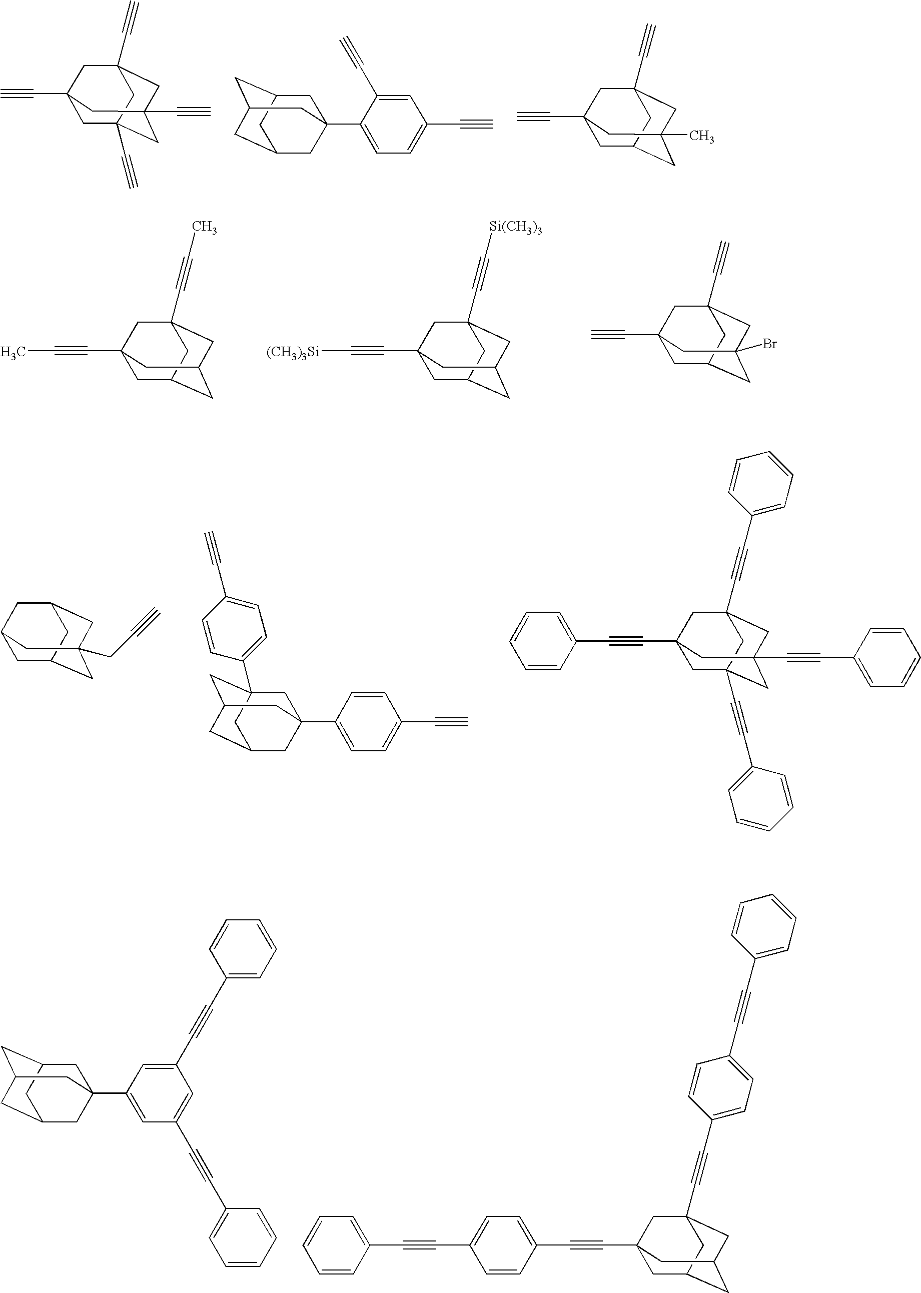

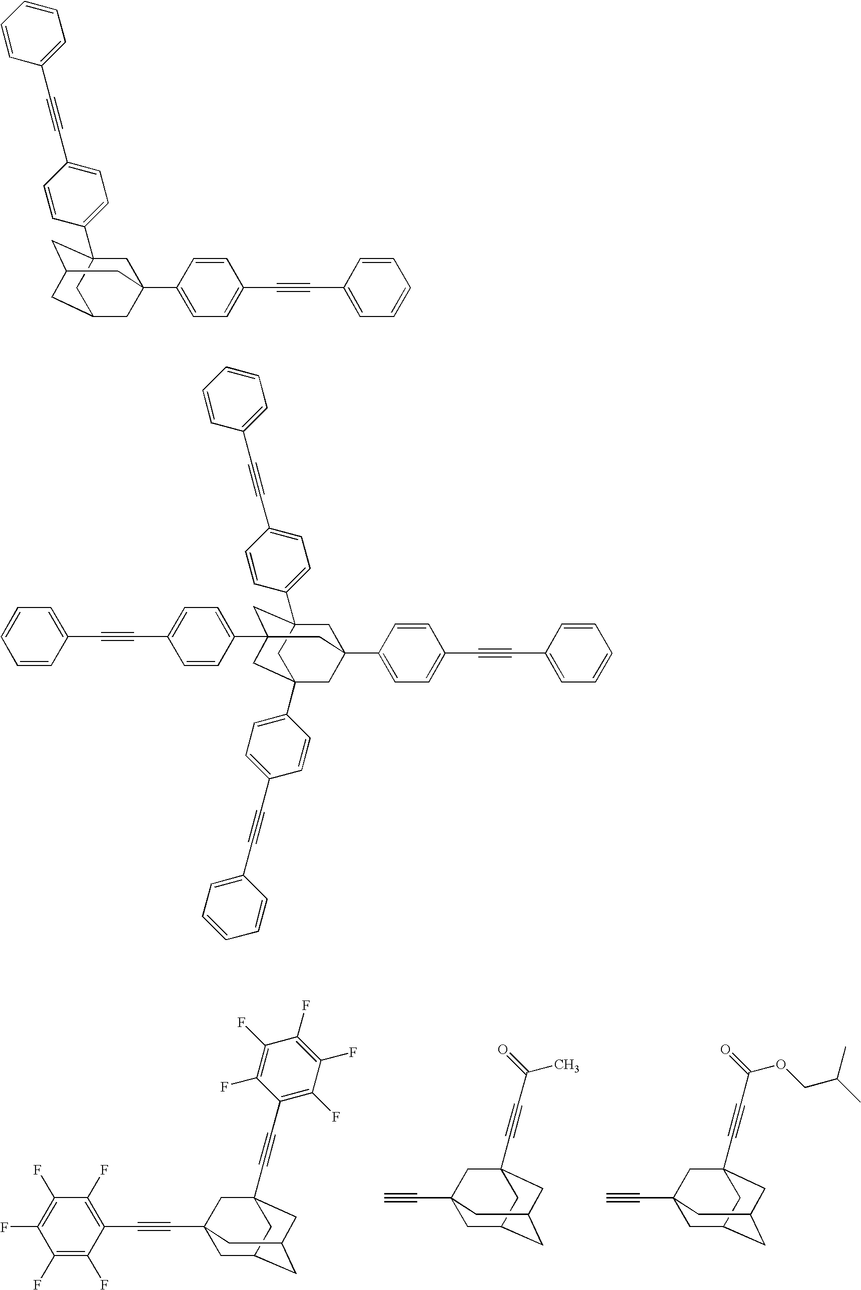

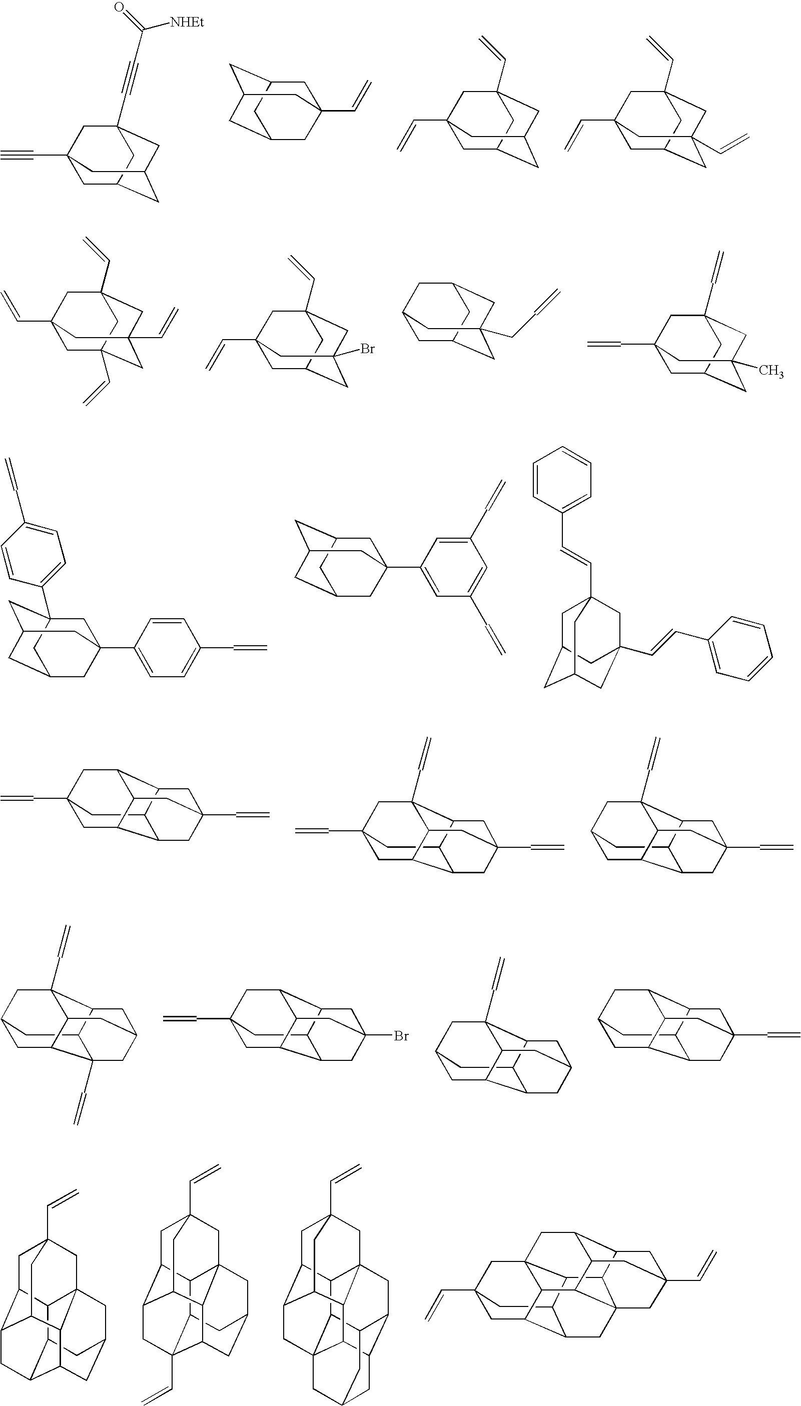

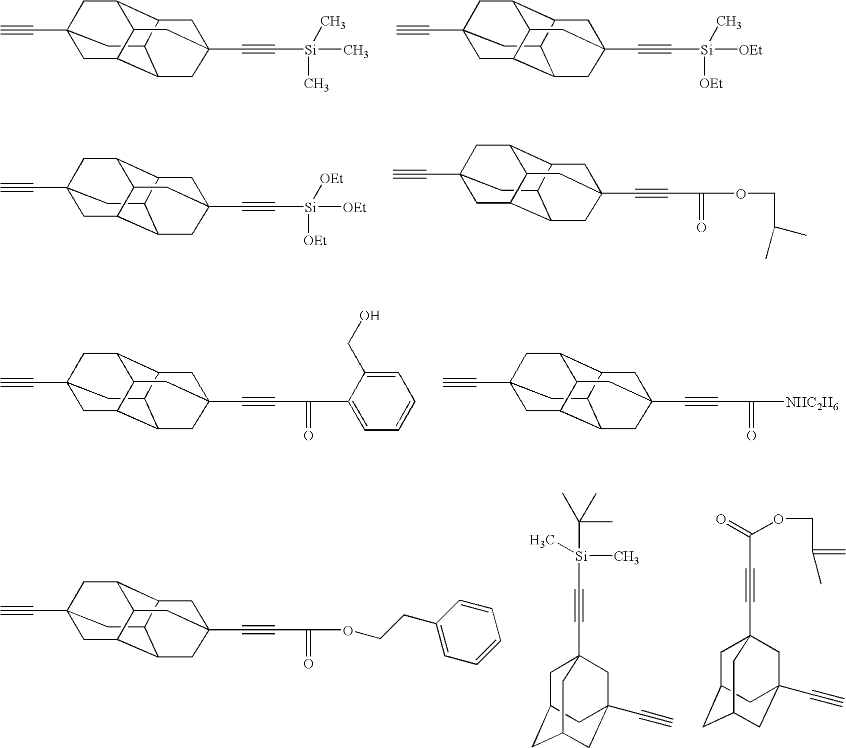

The compound having a cage structure according to the invention can be synthesized, for example, by using commercially available diamantane as a raw material, reacting it with bromine in the presence or absence of an aluminum bromide catalyst to introduce a bromine atom into the desired position of diamantane, causing a Friedel-Crafts reaction between the resulting compound with vinyl bromide in the presence of a Lewis acid such as aluminum bromide, aluminum chloride or iron chloride to introduce a 2,2-dibromoethyl group, and then converting it into an ethynyl group by the HBr elimination using a strong base. More specifically, it can be synthesized in accordance with the process described in Macromolecules 24, 5266-5268 (1991) or 28, 5554-54560 (1995) Journal of Organic Chemistry 39, 2995-3003 (1974) or the like.

An alkyl group or silyl group may be introduced by making the hydrogen atom of the terminal acetylene group anionic by butyl lithium or the like and then reacting the resulting compound with an alkyl halide or silyl halide.

As another mode of the compound having a cage structure to be used in the invention, on the other hand, compounds having a silsesquioxane structure shown below can also be preferred. In other words, the compound having a cage structure for use in the invention is preferably a compound having m pieces of RSi(O_{0.5})₃ units (wherein m stands for integer from 8 to 16 and Rs each independently represents a nonhydroyzale group, with the proviso that at least two of Rs each represents a vinyl- or ethynyl-containing group), each of which forms the above-described cage structure by liking to another RSi(O_{0.5})₃ unit via an oxygen atom possessed in common.

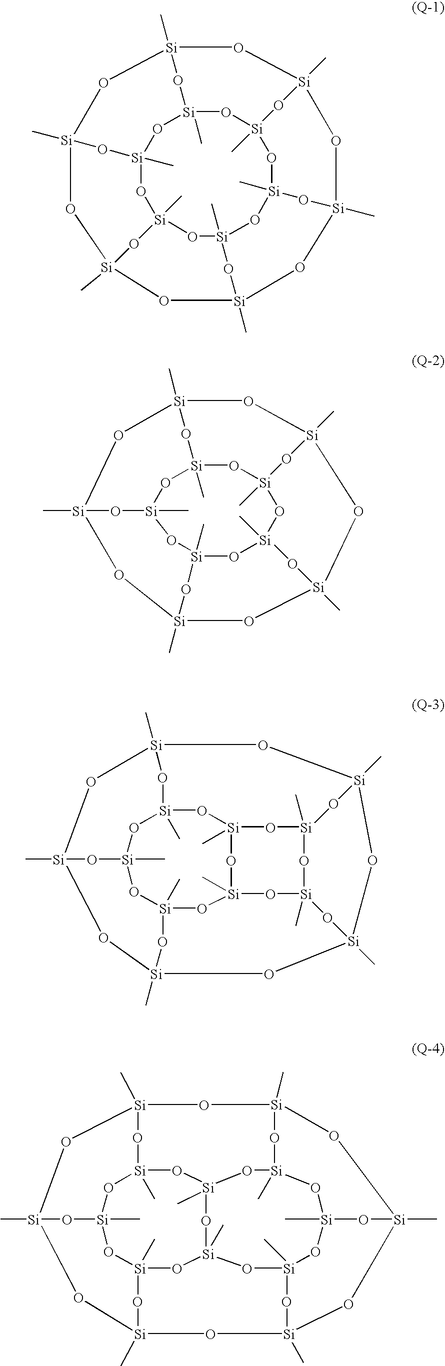

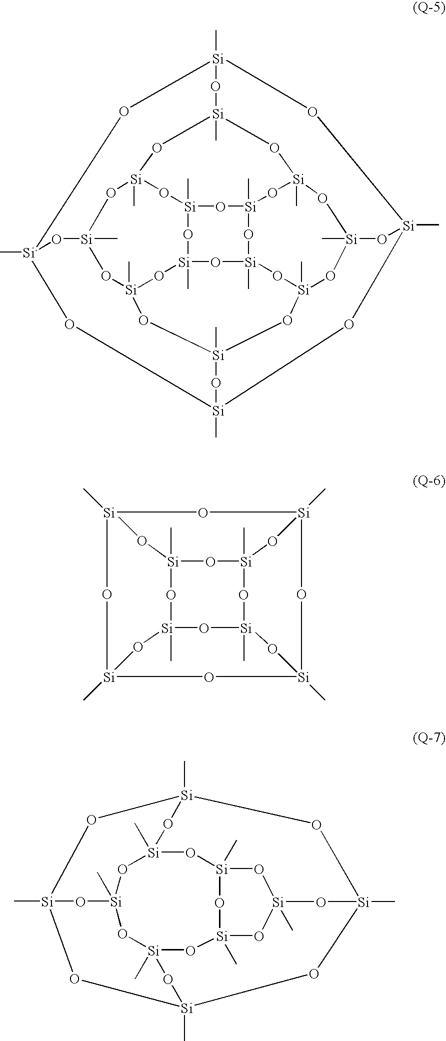

The free bond in the above formulas represents a position at which each of Rs is bonded and Rs each independently represents a nonhydrolyzable group.

The term “nonhydrolyzable group” as used herein means a group whose remaining ratio is 95% or greater, preferably 99% or greater when the group is brought into contact with one equivalent of neutral water at room temperature for one hour.

At least two of Rs are vinyl- or ethyl-containing groups. Examples of the nonhydrolyzable group as R include alkyl groups (such as methyl, t-butyl, cyclopentyl and cyclohexyl), aryl groups (such as phenyl, 1-naphthyl and 2-naphthyl), vinyl group, ethynyl group, allyl group, and silyloxy groups (such as trimethylsilyloxy, triethylsilyloxy and t-butyldimethylsilyloxy).

At least two of Rs are vinyl- or ethynyl-containing groups, but it is preferred that at least two of Rs are vinyl groups. When the group represented by R is a vinyl- or ethynyl-containing group, the vinyl or ethynyl group is preferably bonded, directly or via divalent linking group, to a silicon atom to which R is bonded. Examples of the divalent linking group include —[C(R¹¹)(R¹²)]ₖ—, —CO—, —O—, —N(R¹³)—, —S—, and —O—Si(R¹⁴)(R¹⁵)— (in which R¹¹ to R¹⁵ each independently represents a hydrogen atom, methyl group or ethyl group and k stands for an integer from 1 to 6) and divalent linking groups obtained using the above-described groups in any combination. Of these, —[C(R¹¹)(R¹²)]ₖ—, —O—, and —O—Si(R¹⁴)(R¹⁵)— and divalent linking groups obtained using these groups in any combination are preferred. The vinyl or ethynyl group is preferably directly bonded to a silicon atom to which R is bonded.

It is more preferred that at least two vinyl groups of Rs are directly bonded to a silicon atom to which R is bonded. It is still more preferred that at least half of Rs are each a vinyl group. It is especially preferred that Rs are all vinyl groups.

The compound having a silsesquioxane structure is preferably a polymer obtained by polymerization at the vinyl or ethynyl group represented by R.

Specific examples (monomer) of the above-described compound win next be shown.

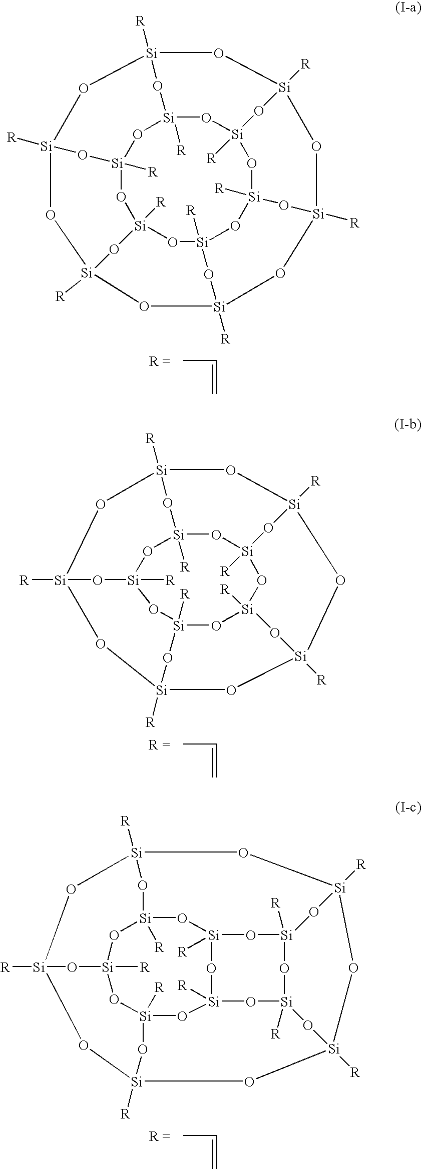

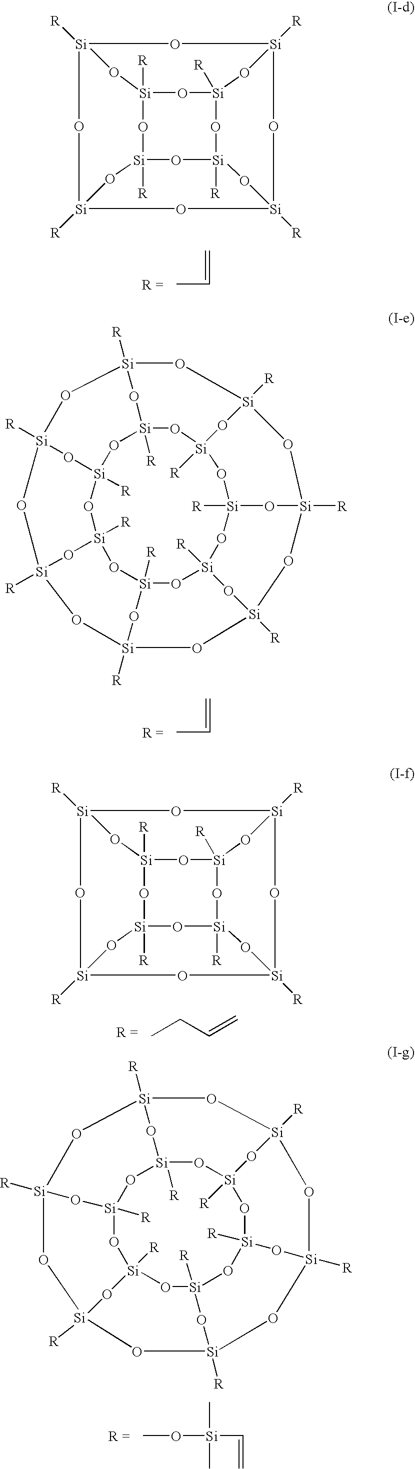

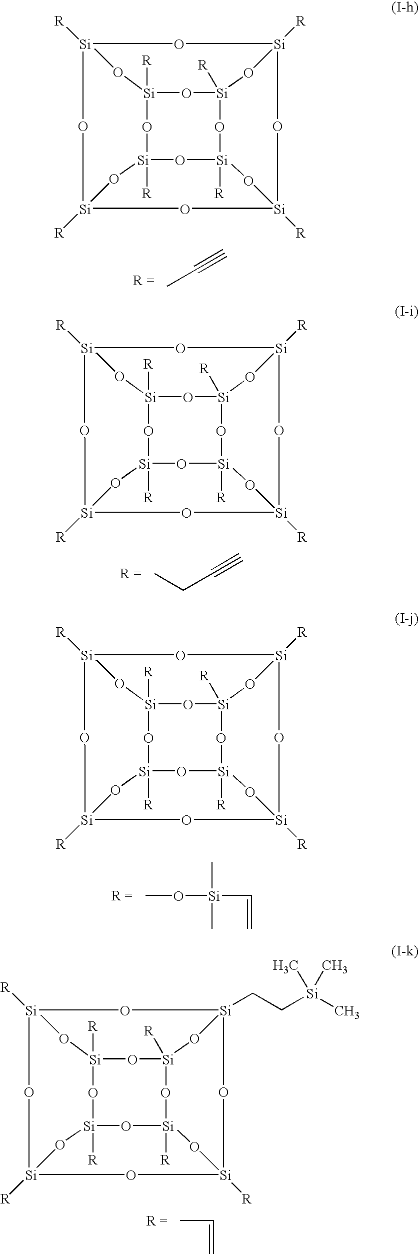

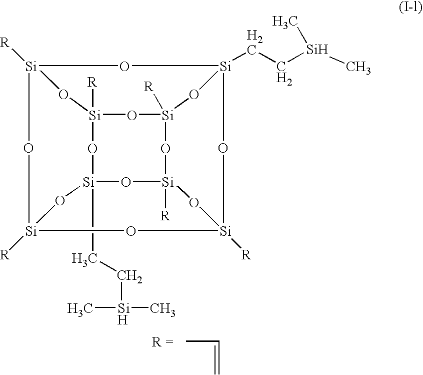

The compound having Pa silsesquioxane structure may be a commercially available compound or may be synthesized in a known manner (J. Am. Chem. Soc. 111, 1741 (1989) or the like).

The compound having a cage structure for use in the invention preferably has a reactive group that forms a covalent bond with another molecule by heating. Although no particular limitation is imposed on such a reactive group, substituents that cause, for example, a cycloaddition reaction or radical polymerization reaction are preferred. For example, combinations of groups having a double bond (such as vinyl and allyl), groups having a triple bond (such as ethynyl and phenylethynyl), and a diene group and a dienophile group for causing a Diels-Alder reaction are effective. Of these, a combination of ethynyl and phenylethynyl groups is effective.

The compound having a cage structure for use in the invention is preferably free of a nitrogen atom which will otherwise increase a molar polarization ratio or be a causative of hygroscopicity of an insulating film, because it has an action of increasing a dielectric constant. In particular, a polyimide compound cannot contribute to a sufficient reduction in dielectric constant so that the compound contained in the composition of the invention and having a cage structure is preferably a compound other than a polyimide compound, that is, a compound having neither a polyimide bond nor amide bond.

It is especially preferred that the compound having a cage structure according to the invention is obtained by dissolving the above-described monomer in a solvent, and adding a polymerization initiator to the resulting solution to cause a reaction with the polymerizable group.

Although any polymerization reaction can be employed, examples include radical polymerization, cationic polymerization, anionic polymerization, ring-opening polymerization, polycondensation, polyaddition, addition condensation and polymerization in the presence of a transition metal catalyst.

The polymerization reaction of the monomer is carried out preferably in die presence of a non-metallic polymerization initiator. For example, the monomer can be polymerized in the presence of a polymerization initiator that generates, by heating, a free radical such as carbon radical or oxygen radical and thereby shows activity.

As the polymerization initiator, organic peroxides and organic azo compounds are preferred.

Preferred examples of the organic peroxide include ketone peroxides such as “PERHEXA H”, peroxyketals such as “PERHEXA TMH”, hydroperoxides such as “PERBUTYL H-69”, dialkyl peroxides such as “PERCUMLYL D”, “PERBUTYL C” and “PERBUTYL D”, diacyl peroxides such as “NYPER BW”, peroxyesters such as “PERBUTYL Z” and “PERBUTYL L”, and peroxydicarbonates such as “PEROYL TCP”, (each, trade name; commercially available from NOF Corporation), and “Luperox 11” (trade name, commercially available: from ARKEMA Yoshitomi).

Preferred examples of the organic azo compound include azonitrile compounds such as “V-30”, “V-40”, “V-59”, “V-60”, “V-65” and “V-70”, azoamide compounds such as “VA-080”, “VA-085”, “VA-086”, “VF-096”, “VA-110” and “VAm-111, cyclic azoamidine compounds such as “V-044” and “VA-061”, and azoamidine compounds such as “V-50” and VA-057” (each, trade name, commercially available from Wako Pure Chemical Industries).

As the polymerization initiator, the organic peroxides are preferred.

In the inventions these polymerization initiators may be used either singly or as a mixture.

In the invention, the polymerization initiator is used in an amount of preferably from 0.001 to 2 moles, more preferably from 0.05 to 1 mole, especially preferably from 0.01 to 0.5 mole, per mole of the monomer.

Examples of the adding method of the polymerization intiator in the invention include batch addition divided addition and continuous addition. Of these, batch addition and continuous addition are preferred because they enable preparation of a polymer having a high molecular weight even if the amount of the polymerization initiator is small.

The polymerization reaction of the monomer in the invention can also be effected preferably in the presence of a transition met catalyst. For example, it is preferred to carry out polymerization of a monomer having a polymerizable carbon-carbon double bond or carbon-carbon triple bond, for example, in the presence of a Pd catalyst such as Pd(PPh₃)₄ or Pd(OAc)₂, a Ziegler-Natta catalysts an Ni catalyst such as nickel acetylacetonate, a W catalyst such as WCl₆, an Mo catalyst such as MoCl₅, a Ta catalyst such as TaCl₅, an Nb catalyst such as NbCl⁵, an Rh catalyst or a Pt catalyst.

These transition meal catalysts may be used either singly or as a mixture.

In the invention the amount of the transition metal catalyst is preferably from 0.001 to 2 moles more preferably from 0.01 to 1 mole, especially preferably from 0.05 to 0.5 mmole per mole of the monomer.

For the polymerization reaction, any solvent is usable so far as it can dissolve the monomer having a cage structure therein at a required concentration and does not adversely affect the properties of the fin formed from the polymer obtained. Examples of the solvent include water; alcohol solvents such as methanol, ethanol and propanol; ketone solvents such as acetone, methyl ethyl ketone, methyl isobutyl ketone, cyclohexanone and acetophenone ester solvent such as methyl acetate, ethyl acetate, propyl acetate, isopropyl acetate, butyl acetate, pentyl acetate, hexyl acetate, methyl propionate, ethyl propionate, propylene glycol monomethyl ether acetate, γ-butyrolactone and methyl benzoate; ether solvents such as dibutyl ether, anisole and tetrahydrofuran; aromatic hydrocarbon solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-orthoxylene, 1-methylnaphthalene and 1,3,5-triisopropylbenzene; amide solvents such as N-methylpyrrolidinone and dimethylacetamide; halogen solvents such as carbon tetrachloride, dichloromethane, chloroform, 1,2-dichloroethane, chlorobenzene, 1,2-dichlorobenzene and 1,2,4-trichlorobenzene; and aliphatic hydrocarbon solvents such as hexane, heptane, octane and cyclohexane. Of these solvents, preferred are the ester solvents, of which methyl acetate, ethyl acetate, propyl acetate, isopropyl acetate, butyl acetate, pentyl acetate, hexyl acetate, methyl propionate, ethyl propionate, propylene glycol monomethyl ether acetate, γ-butyrolactone, and methyl benzoate are more preferred, with ethyl acetate and butyl acetate being especially preferred.

These solvents may be used either singly or as a mixture.

When the solvent is the same, as the concentration of the monomer having a cage structure is smaller at the time of polymerization a composition having a greater weight average molecular weight and a greater number average molecular weight and soluble in an organic solvent can be synthesized easily. In this sense, the concentration of the monomer having a cage structure in the reaction mixture is preferably 30 mass % or less, more preferably 10 mass % or less, still more preferably 5 mass % or less.

The productivity at the time of the reaction is, on the other hand, better when the concentration of the monomer having a cage structure is higher at the time of polymerization. In is sense, the concentration for the monomer having a cage structure at the time of polymerization is preferably 0.1 mass % or greater, more preferably 1 mass % or greater.

The optimum conditions of the polymerization reaction in the invention differ, depending on the kind, concentration or the like of the polymerization initiator, monomer or solvent. The polymerization reaction is effected at a bulk temperature preferably from 0 to 200° C., more preferably from 40 to 170° C., especially preferably from 70 to 150° C. for a polymerization time preferably from 1 to 50 hours, more preferably from 2 to 20 hours, especially preferably from 3 to 10 hours.

The reaction is conducted preferably in an inert gas atmosphere (for example, nitrogen or argon) in order to suppress the inactivation of the polymerization initiator which will otherwise occur by oxygen. The oxygen concentration during the reaction is preferably 100 ppm or less, more preferably 50 ppm or less, especially preferably 20 ppm or less.

### <Photosensitive Compound>

The composition of the invention contains preferably a photosensitive compound.

As the photosensitive compound in the invention, compounds having photosensitivity to an electron beam or an electromagnetic wave having a wavelength greater than 200 nm or compounds having a functional group having photosensitivity to an electron beam or an electromagnetic wave having a wavelength greater an 200 nm are usable. Examples of such compounds include trihalomethyl compounds, carbonyl compounds, organic peroxides, azo compounds, azide compounds, metallocene compounds, hexaarylbiimidazole compounds, organic boron compounds, disulfone compounds, oxime ester compounds, and onium salt compounds. Two or more of these compounds may be used in combination as needed.

Examples of the hexaarylbiimidazole polymerzation initiator include lophine dimers described in Japanese Patent Publication Nos. 37377/1970 and 86516/1969 such as 2,2′-bis(o-chlorophenyl)-4,4′,5,5′-tetraphenylbiimidazole, 2,2′ bis(o-bromophenyl)-4,4′,5,5′-tetraphenylbiimidazole, 2,2′-bis(o,o-dichlorophenyl)-4,4′,5,5′-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5′-tetraphenylbiimidazole, and 2,2′-bis(o-trifluoromethylphenyl)-4,4′,5,5′-tetraphenylbiimidazole.

As the trihalomethyl compound, trihalmethyl-s-triazines are preferred and examples include s-triazine derivatives having a trihalogen-substituted methyl group described in Japanese Patent Laid-Open No. 29803/1983 such a 2,4,6-tris(trichloromethyl)-s-triazine, 2-methoxy-4,6-bis(trichloromethyl)-s-triazine, 2-amino-4,6-bis(trichloromethyl)-s-triazine, and 2-(P-methoxystyryl)-4,6-bis(trichloromethyl)-s-triazine.

Examples of the onium salts include those represented by the following formula (A).

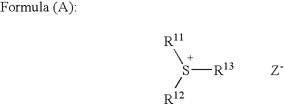

In the formula (A), R¹¹, R¹² and R¹³ may be the same or different and each represents an optionally substituted hydrocarbon group having 20 or less carbon atoms. Preferred examples of the substituent include halogen atoms, nitro, group, alkyl groups having 12 or less carbon atoms, alkoxy groups having 12 or less carbon atoms and aryloxy groups having 12 or less carbon groups.

Z″ represents a counterion selected from the group consisting of halogen ions, perchlorate ions, tetrafluoroborate ions, hexafluorophosphate ions, carboxylate ions and sulfonate ions, of which perchlorate ions, hexafluorophosphate ions, carboxylate ions and arylsulfonate ions are preferred.

As the titanocene compound, known compounds described in, for example, Japanese Patent Laid-open Nos. 152396/1984 and 151197/1986 can be used as needed after selection.

Specific examples include di-cyclopentadienyl-Ti-di-chloride, di-cyclopentadien-Ti-bis-phenyl, di-cyclopentadienyl-Ti-bis-2,3,4,6-pentafluorophen-1-yl, di-cyclopentadienyl-Ti-bis-2,3,5,6-tetrafluorophen-1-yl, di-cyclopentadienyl-Ti-bis-2,4,6-trifluorphen-1-yl, di-cyclopentadienyl-Ti-bis-2,6-di-fluorophen-1-yl, di-cyclopentadienyl-Ti-bis-2,4-di-fluorophen-1-yl, di-methylcyclopentadienyl-Ti-bis-2,3,4,5,6-pentafluorophen-1-yl, di-methylcyclopentadienyl-Ti-bis-2,3,5,6-tetrafluorophen-1-yl, di-methylcylopentadienyl-Ti-bis 2,4-difluorophen-1-yl and bis(cyclopentadienyl)-bis[2,6-difluoro-3-(pyrr-1-yl)phenyl]titanium.

Examples of the carbonyl compound include benzophenone derivatives such as benzophenone, Michler's ketone, 2-methylbenzophenone, 3-methylbenzophenone, 4-methylbenzophenone, 2-chlorobenzophenone, 4-bromobenzophenone and 2-carboxybenzophenone, acetophenone derivatives such as 2,2-dimethoxy-2-phenylacetophenone, 2,2-diethoxyacetophonone, 1-hydroxycyclohexylphenylketone, α-hydroxy-2-methylphenylpropanone, 1-hydroxy-1-methylethyl-(p-isopropylphenyl)ketone, 1-hydroxy-1-(p-dodecylphenyl)ketone, 2-methyl-(4′-methylthio)phenyl-2-morpholino-1 propanone and 1,1,1-trichloromethyl-(p-butylphenyl)ketone, thioxantone derivatives such as thioxantone, 2-ethylthioxanthone, 2-isopropylthioxantone, 2-chlorothioxantone, 2,4-dimethylthioxanthone, 2,4-diethylthioxatone and 2,4-diisopropylthioxantone, and benzoate derivatives such as ethyl p-dimethylaminobenzoate and ethyl p-diethylaminobenzoate.

Examples of the oximester compound include compounds described in J.C.S. Perkin II, 1653-1660 (1979), J. C. S Perkin II, 156-162 (1979), Journal of Photopolymer Science and Technology, 202-232 (1995), and Japanese Patent Laid-Open Nos. 2000-66385 and 2000-80068.

Those photosensitive compounds in the invention are preferably used either singly or in combination.

In the invention, the amount of the photosensitive compound is preferably from 0.01 to 50 mass %, more preferably from 0.1 to 40 mass %, still more preferably from 1.0 to 30 mass %, based on the mass of the whole solid component of the composition.

In the invention, a ratio of the number of atoms other than carbon, hydrogen and oxygen atoms to the numbers of carbon, hydrogen and oxygen atoms in the photosensitive compound is preferably from 0 to 0.25, more preferably from 0 to 0.2, still more preferably from 0 to 0.1 assuming that the number of carbon, hydrogen and oxygen atoms is 1

### <Film Forming Composition>

When the composition of the invention is prepared, the reaction mixture obtained by the polymerization reaction of the monomer having a cage structure may be used as is as the composition of the invention. The reaction mixture is preferably used as a concentrate by distilling off the reaction solvent. In additions the reaction mixture is preferably used after re-precipitation treatment.

The reaction mixture is concentrated preferably by heating and/or pressure reduction in a rotary evaporator, distiller or reaction apparatus employed for the polymerization reaction. The temperature of the reaction mixture at the time of concentration is typically from 0 to 180° C., preferably from 10 to 140° C., more preferably from 20 to 100° C., most preferably from 30 to 60° C. The pressure at the time of concentration is typically from 0.133 Pa to 100 kPa, preferably from 1.33 Pa to 13.3 kPa, more preferably from 1.33 Pa to 1.33 kPa.

When the reaction mixture is concentrated, it is concentrated until the solid content in the reaction mixture reaches preferably 10 mass % or greater, more preferably 30 mass % or greater, most preferably 50 mass % or greater.

In the invention, the polymer of a monomer having a cage structure is preferably dissolved in an appropriate solvent and the resulting solution is then applied onto a substrate. Examples of the usable solvent include ethylene dichloride, cyclohexanone, cyclopentanone, 2-heptanone, methyl isobutyl ketone, γ-butyrolactone, methyl ethyl ketone, methanol, ethanol, dimethylimidazolidinone, ethylene glycol monomethyl ether, ethylene glycol monoethyl ether, ethylene glycol dimethyl ether, 2-methoxyethyl acetate, ethylene glycol monoethyl ether acetate, propylene glycol monomethyl ether (PGMG), propylene glycol monomethyl ether acetate (PGMEA), tetraethylene glycol dimethyl ether, triethylene glycol monobutyl ether, triethylene glycol monomethyl ether, isopropanol, ethylene carbonate ethyl acetate, butyl acetate, methyl lactate, ethyl lactate, methyl methoxypropionate, ethyl ethoxypropionate, methyl pyruvate, ethyl pyruvate, propyl pyruvate, N,N-dimethylformamide, dimethylacetamide, dimethylsulfoxide, N-methylpyrrolidone, tetrahydrofuran, diisopropylbenzene, toluene, xylene, and mesitylene. These solvents may be used either singly or as admixtures.

Of these solvents, preferred examples of the solvent include propylene glycol monomethyl ether acetate, propylene glycol monomethyl ether, 2-heptanone, cyclohexanone, γ-butyrolactone, ethylene glycol monomethyl ether, ethylene glycol monoethyl ether, ethylene glycol monoethyl ether acetate, propylene glycol monomethyl ether, propylene glycol monoethyl ether, ethylene carbonate, butyl acetate, methyl lactate, ethyl lactate, methyl methoxypropionate, ethyl ethoxypropionate, N-methylpyrrolidone, N,N-dimethylformamide, tetrahydrofuran, methyl isobutyl ketone, xylene, mesitylene and diisopropylbenzene.

A solution obtained by dissolving the composition of the invention in an appropriate solvent is also embraced in the scope of the composition of the invention. A total solid concentration in the solution of the invention is preferably from 1 to 30 mass %. It is suitably regulated according to the using purpose. When a total solid concentration of the composition falls within a range of from 1 to 30 mass %, the thickness of a coating falls within an appropriate range, and the coating solution has better storage stability.

The composition of the invention may contain a polymerization initiator, but the composition free of a polymerization initiator is preferred because it has better storage stability.

When the composition of the invention must be cured into a film at low temperatures, however, it preferably contains a polymerization initiator. In such a case, examples of the polymerization initiator may be the same as those cited above. Also an initiator that induces polymerization when exposed to radiation may also be used for this purpose.

The content of metals, as an impurity, of the film forming composition of the invention is preferably as small as possible. The metal content of the film forming composition can be measured with high sensitivity by the ICP-MS and in this case, the content of metals other an transition metals is preferably 30 ppm or less, more preferably 3 ppm or less, especially preferably 300 ppb or less. The content of the transition metal is preferably as small as possible because it accelerates oxidation by its high catalytic capacity and the oxidation reaction in the prebaking or thermosetting process decreases the dielectric constant of the film obtained by the invention. The metal content is preferably 10 ppm or less, more preferably 1 ppm or less, especially preferably 100 ppb or less.

The metal concentration of the film forming composition can also be evaluated by subjecting a film obtained using the film forming composition of the invention to total reflection fluorescent X-ray analysis. When W my is employed as an X-ray source, the metal concentrations of metal elements such as K, Ca, Ti, Cr, Mn, Fe, Co, Ni, Cu, Zn, and Pd can be measured. The concentrations of them are each preferably from 100×10¹⁰ atom·cm⁻² or less, more preferably 50×10¹⁰ atom·cm⁻² or less, especially preferably 10×10¹⁰ atom·cm⁻² or less. In addition, the concentration of Br as a halogen can be measured. Its remaining amount is preferably 1000×10¹⁰ atom·cm⁻² or less, more preferably 1000×10¹⁰ atom·cm⁻², especially preferably 400×10¹⁰ atom·cm⁻². Moreover, the concentration of Cl can also be observed as a halogen. In order to prevent it from damaging a CVD device, etching device or the like, its remaining amount is preferably 100×10¹⁰ atom·cm⁻² or less, more preferably 50×10¹⁰ atom·cm⁻⁴ especially preferably 10×10¹⁰ atom·cm⁻².

To the film fanning composition of the invention, additives such as radical generator, colloidal silica, surfactant, silane coupling agent and adhesive agent may be added without impairing the properties (such as heat resistance, dielectric constant, mechanical strength, coatability, and adhesion) of an insulating film obtained using it.

Any colloidal silica may be used in the invention. For example, a dispersion obtained by dispersing high-purity silicic anhydride in a hydrophilic organic solvent or water and having usually an average particle size of from 5 to 30 nm, preferably from 10 to 20 nm and a solid concentration of from about 5 to 40 mass % can be used.

Any surfactant may be added in the invention. Examples include nonionic surfactants, anionic surfactants and cationic surfactants. Further examples include silicone surfactants, fluorosurfactants, polyalkylene oxide surfactants, and acrylic surfactants. In the invention, these surfactants can be used either singly or in combination. As the surfactant, silicone surfactants, nonionic surfactants, fluorosurfactants and acrylic surfactants are preferred, with silicone surfactants being especially preferred.

The amount of the surfactant to be used in the invention is preferably from 0.01 mass % or greater but not greater than 1 mass %, more preferably from 0.1 mass % or greater but not greater than 0.5 mass % based on the total amount of the film forming coating solution.

The term “silicone surfactant” as used herein means a surfactant containing at least one Si atom. Any silicone surfactant may be used in the invention, but it preferably has a structure containing an alkylene oxide and dimethylsiloxane, of which a silicone surfactant having a compound represented by the following chemical formula is more preferred:

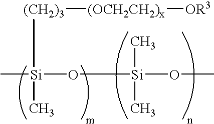

In the above formula, R³ represents a hydrogen atom or a C₁₋₅ alkyl group, x stands for an integer of from 1 to 20, and m and n each independently represents an integer of from 2 to 100. A plurality of R³s may be the same or different.

Examples of the silicone surfactant to be used in the invention include “BYK 306”, “BYK 307” (each, trade name; product of BYK Chemie), “SH7PA”, “SH21PA”, “SH28PA”, and “SH30PA” (each, trade name; product of Dow Corning Toray Silicone) and Troysol S366 (trade name; product of Troy Chemical).

As the nonionic surfactant to be used in the invention, any nonionic surfactant is usable. Examples include polyoxyethylene alkyl ethers, polyoxyethylene aryl ethers, polyoxyethylene dialkyl esters, sorbitan fatty acid esters, fatty-acid-modified polyoxyethylenes, and polyoxyethylene-polyoxypropylene block copolymers.

As the fluorosurfactant to be used in the invention, any fluorosurfactant is usable. Examples include perfluorooctyl polyethylene oxide, perfluorodecyl polyethylene oxide and perfluorododecyl polyethylene oxide.

As the acrylic surfactant to be used in the invention, any acrylic surfactant is usable. Examples include (methyl)acrylic acid copolymer.

Any silane coupling agent may be used in the invention. Examples include 3-glycidyloxypropyltrimethoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltrimethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-triethoxysilylpropyltriethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane, Those silane coupling agents may be used either singly or in combination. The silane coupling agent may be added preferably in an amount of 10 parts by weight or less, especially preferably from 0.05 to 5 parts by weight based on 100 part by weight of the whole solid content.

In the invention, any adhesion accelerator may be used. Examples include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane trimethoxyvinylsilane, γ-aminopropytriethoxysilane, aluminum monoethylacetoacatate disopropylate, vinyltris(2-methoxyethoxy)silane, N-(2-aminoethyl-3-aminopropylmethyldimethoxysilane, N-(2-aminoethyl)-3-aminopropyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, trimethylchlorosilane, dimethylvinylchlorosilane, methyldiphenylchlorosilane, chloromethyldimethylchlorosilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, vinyltrichlorosilane, benzotriazole, benzimidazole, indazole, imidazole, 2-mercaptobenzimidazole, 2-mercaptobenzothiazole, 2-mercaptobenzoxazole, urazole, thiourasil, mercaptoimidazole, mercaptopyrimidine, 1,1-dimethylurea, 1,3-dimethylurea and thiourea compounds. A functional silane coupling agent is preferred as an adhesion accelerator. The amount of the adhesion accelerator is preferably 10 parts by weight or less, especially preferably from 0.05 to 5 parts by weight, based or 100 parts by weight the total solid content.

It is possible to add a pore forming factor to the composition of the invention to the extent allowed by the chemical strength of a film in order to make a film porous and thereby reduce the dielectric constant thereof.

Although the pore forming factor which will be an additive serving as a pore forming agent is not particularly limited, non-metallic compounds are preferred. They must satisfy both solubility in solvent used for a film forming coating solution and compatibility with the polymer of the invention.

A polymer may also be used as the pore forming agent. Examples of the polymer usable as the pore forming agent include aromatic polyvinyl compounds (such as polystyrene, polyvinylpyridine, and halogenated aromatic polyvinyl compound), polyacrylonitrile, polyalkylene oxides (such as polyethylene oxide and polypropylene oxide), polyethylene, polylactic acid, polysiloxane, polycaprolactone, polycaprolactam, polyurethane, polymethacrylates (such as polymethyl methacrylate), polymethacrylic acid, polyacrylates (such as polymethyl acrylate), polyacrylic acid, polydienes (such as polybutadiene and polyisoprene), polyvinyl chloride, polyacetal, amine-capped alkylene oxides, polyphenylene oxide, poly(dimethylsiloxane), polytetrahydrofuran, polycyclohexylethylene, polyethyloxazoline, polyvinylpyridine, and polycaprolactone.

Polystyrene is especially preferred as the pore forming agent. Examples of the polystyrene include anionically polymerized polystyrene, syndiotactic polystyrene and unsubstituted and substituted polystyrenes (such as poly(α-methylstyrene)), among which the non-substituted polystyrene is preferred.

Thermoplastic polymers may also be used as the pore forming agent. Examples of the thermoplastic pore-forming polymer include polyacrylate, polymethacrylate, polybutadiene, polyisoprene, polyphenylene oxide, polypropylene oxide, polyethylene oxide poly(dimethylsiloxane), polytetrahydrofuran polyethylene, polycyclohexylethylene, polyethyloxazoline, polycaprolactone, polylactic acid and polyvinylpyridine.

Such pore forming agent has a boiling point or decomposition point of preferably from 100 to 500° C., more preferably from 200 to 450° C., especially preferably from 250 to 400° C. The molecular weight thereof is preferably from 200 to 50,000, more preferably from 300 to 10,000, especially preferably from 400 to 5,000. The pore forming agent is added in an amount, in terms of mass % relative to the film-forming polymer, of preferably from 0.5 to 75%, more preferably from 0.5 to 30%, especially preferably from 1 to 20%.

The polymer may contain a decomposable group as a pore forming factor. The decomposition point; thereof is preferably from 100 to 500° C., more preferably from 200 to 450° C., especially from 250 to 400° C. The content of the decomposable group is, in terms of mole % relative to the amount of the monomer in the film-forming polymer, preferably from 0.5 to 75%, more preferably from 0.5 to 30%, especially preferably from 1 to 20%.

The film forming composition of the invention is used for film formation preferably after elimination therefrom of insoluble matters, gel-like components and the like by filtration trough a filter. The filter to be used for such a purpose preferably has a pore size of from 0.001 to 0.2 μm, more preferably from 0.003 to 0.05 μm, most preferably from 0.01 to 0.03 μm. The filter is preferably made of PTFE, polyethylene or nylon, more preferably polyethylene or nylon.

The film available by using the film forming composition of the invention can be formed by applying the film forming composition onto a substrate such as silicon wafer, SiO₂ wafer, SiN wafer, glass or plastic film by a desired method such as spin coating, roller coating, dip coating or scan coating, spraying or bar coating and then removing the solvent by heating if necessary. As the method of applying the composition to the substrate, spin coating and scan coating are preferred, with spin coating being especially preferred. For spin coating, commercially available apparatuses such as “Clean Track Series” (trade name; product of Tokyo Electron), “D-Spin Series” (trade name; product of Dainippon Screen), and “SS series” and “CS series” (each, trade name; product of Tokyo Oka Kogyo) are preferably employed. The spin coating may be performed at any rotation speed, but from the standpoint of in-plane uniformity of the film, a rotation speed of about 1300 rpm is preferred for a 300-mm silicon substrate. When the solution of the composition is discharged, either dynamic discharge by which the solution is discharged onto a rotating substrate or static discharge by which the solution is discharged onto a static substrate may be employed. The dynamic discharge is however preferred from the standpoint of the in-plane uniformity of the film. Alternatively, from the viewpoint of reducing the consumption amount of the composition, a method of discharging only the main solvent of the composition to a substrate in advance to form a liquid coating and then discharging the composition thereon can be employed. Although no particular limitation is imposed on the spin coating time, it is preferably within 180 seconds from the viewpoint of throughput. From the viewpoint of the transport of the substrate, treatment (such as edge rinse or back rinse) for preventing the remaining of the film at the edge portion of the substrate is preferably employed.

By heat treating the film formed by the application of the film forming composition of the invention, the coating solvent which has still remained can be removed by volatilization. The heat treatment method is not particularly limited, but ordinarily employed methods such as hot plate heating, heating with a furnace, heating in an RTP (Rapid Thermal Processor) or the like to expose the substrate to light of a xenon lamp can be employed. Of these, hot plate heating or heating with a furnace is preferred. The temperature at the time of hating must be sufficiently high to volatilize the coating solvent and at the same time, sufficiently low not to give damage to the film. When the heat treatment is performed in practice, the temperature is preferably higher than 50° C. but lower than 500° C. more preferably higher than 80° C. but lower than 400° C., most preferably higher than 100° C. but lower than 300° C. In order to prevent deterioration of the film such as oxidation, exposure to an inert gas is preferably employed during heating treatment for volatilizing the coating solvent. The heat treatment for volatilizing the coating solvent is therefore performed in a space filled with, for example, a nitrogen gas or argon gas. The gas flow rate is preferably small enough not to generate unevenness in temperature which will otherwise occur by cooling of the film by the flowing gas. The gas flow rate is, supposing that a space wherein an apparatus for heat treatment is disposed has a volume of 0.5 L, preferably 5 L/min or greater but not greater than 500 L/min, more preferably 10 L/min or greater but not greater than 250 L/min, most preferably 20 L/min or greater but not greater than 100 L/min. As the hot plate, a commercially available one, for example, “Clean Track Series” (trade name, product of Tokyo Electron), “D-Spin Series” (trade name; product of Dainippon Screen) and “SS series” or “CS series” (trade name; product of Tokyo Oka Kogyo) is preferred, while as the furnace, “α series” (trade name; product of Tokyo Electron) is preferred.

In the invention, heat treatment is preferably performed at the time of irradiation of an electron beam or an electromagnetic wave having a wavelength greater than 200 nm. In this case, heating temperate is preferably from 300 to 450° C., more preferably from 300 to 420° C., especially preferably from 350° C. to 400° C.; and heating time is preferably 1 minute to 30 minutes, more preferably from 1 minute to 45 minutes, especially preferably from 1 minute to 30 minutes. Heat treatment may be performed in several stages.

In the invention, when an electron beam is irradiated, it has preferably an energy at which 5% or greater of the number of electrons which have been injected are actually injected into a film, more preferably an energy at which 20% or greater of the number of electrons which have been injected are actually injected into a film, still more preferably an energy at which 50% or greater of the number of electrons which have been injected actually injected into a film.

In the invention, when an electron beam is irradiated, a too large irradiation dose of an electron beam per unit hour damages the film so that the irradiation dose of an electron beam is preferably 1 mA/cm² or less, more preferably 500 μA/cm² or less, still more preferably 300 μA/cm² or less.

In the invention, when an electromagnetic wave having a wavelength greater than 200 nm is irradiated, the energy of the electromagnetic wave in terms of wavelength is preferably greater than 200 nm but smaller than 600 nm. The wavelength of the electromagnetic wave to be used in the invention can however be selected from the electromagnetic wave absorption spectrum of the film forming composition. For example, when a material photosensitivity to a visible light such as camphorquinone or functional group photosensitive to a visible light is used in the composition, an electromagnetic wave in a visible light region can be selected.

In the invention, a film having a dense crosslinked structure can be obtained by forming a film from the film forming composition of the invention over a substrate or the structure of an electronic device and ten exposing it to an electron beam or an electromagnetic wave leaving a wavelength greater than 200 nm.

During the irradiation of an electron beam or electromagnetic wave, the crosslinked structure thus formed can be controlled by heating the film to a desired temperature.

The electron beam is available by using a commercially available electron irradiator.

The electromagnetic wave is available by using a commercially available laser, light source lamp or combined use of a light source 1 amp with a light filter, or monochromator. A white light can also be used.

Although no particular limitation is imposed on the thickness of a film formed using the film forming composition of the invention, it is preferably from 0.001 to 100 μm, more preferably from 0.01 to 10 μm.

The film available using the coating solution containing the composition of the invention is suited for use as an insulating film in semiconductor devices and electronic parts such as multi-chip module multi-layered wiring board. It can be used as a passivation film or α-ray shielding film for LSI, a coverlay film for flexographic printing plate, an overcoat film, a cover coating for a flexible copper-clad board, a solder resist film, a liquid crystal alignment film, optical element forming film and optical waveguide as well as interlayer insulating film for semiconductor, a surface protective film, and a buffer coating film.

### EXAMPLES

The invention will hereinafter be described by Examples. It should however be borne in mind that the present invention is not limited to or by them.

The structures of compounds used in Examples will next be shown.

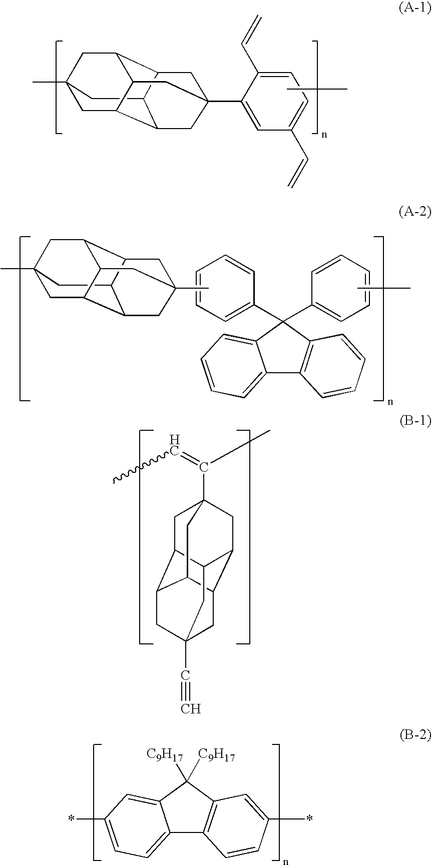

### Synthesis Example 1

In accordance with the process described in Macromolecules 24, 5266 (1991), 4,9-dibromodiamantane was synthesized. A 500-ml flask was charged with 1.30 g of commercially available p-divinylbenzene (product of Aldrich), 3.46 g of the 4,9-dibromodiamantane, 200 ml of dichloroethane and 2.66 g of aluminum chloride. The resulting mixture was stirred at a bulk temperature of 70° C. for 24 hours. Water (200 ml) was then added to the reaction mixture to separate an organic layer therefrom. After addition of anhydrous sodium sulfate, a solid component was filtered off and the dichloroethane was concentrated under reduced pressure until it reduced by half. Methanol (300 ml) was then added to the resulting solution and a precipitate thus formed was collected by filtration, whereby 2.8 g of Polymer (A-1) having a mass average molecular weight of about 10,000 was obtained.

Similarly, Polymer (A-2) having a mass average molecular weight of about 10,000 was synthesized in accordance with a Friedel-Crafts reaction.

### Example 1

In a mixed solvent of 5.0 ml of cyclohexanone and 5.0 ml of anisole was dissolved 1.0 g of Polymer (A-1) under heating to prepare a coating solution. After filtration through a filter made of PTFE and having a pore size of 0.1 μm, the solution was spin-coated on a silicon wafer, followed by heating and drying at 150° C. for 60 seconds on a hot plate in a nitrogen gas stream. The resulting film was baked (aged by heating) for 40 seconds while irradiating it with a 222-nm light at an energy corresponding to 1 mW/cm² by using a dielectric barrier discharge excimer lamp (product of Ushio Inc.) on a hot plate of 350° C. in a nitrogen gas stream. The relative dielectric constant of the resulting insulating film having a thickness of 0.5 μm was calculated from the capacitance value thereof measured at 1 MHz by using a mercury probe (product of Four Dimensions) and an LCR meter “HP4285A” (trade name, product of Yokogawa Hewlett Packard), resulting in 2.53. The Young's modulus of the film was measured using “NANO Indenter SA2” (trade name; product of MTS Nano Instruments), resulting in 7 GPa. The stress in the insulating film was measured before and after heat treatment at 400° C. for 30 minutes by using “FLX-2320” (trade name; product of KLA-Tencor), resulting in a difference of 3% or less.

### Example 2

In a mixed solvent of 5.0 ml of cyclohexanone and 5.0 ml of anisole was dissolved 1.0 g of Polymer (A-1) by heating. To the resulting solution was added 1-hydroxycyclohexyl phenyl ketone (product of Aldrich) at a weight ratio of 0.1 to the solution to prepare a coating solution. After filtration through a filter made of PTFE and having a pore size of 0.1 μm, the solution was spin-coated on a silicon wafer, followed by heating and drying at 150° C. for 60 seconds on a hot plate in a nitrogen gas stream. The film was baked (aged by heating) for 60 seconds while irradiating it with a 222-nm light at an energy corresponding to 5 mW/cm² by using a dielectric barrier discharge excimer lamp (product of Ushio Inc.) on a hot plate of 350° C. in a nitrogen gas stream. The relative dielectric constant of the resulting insulating film having a thickness of 0.5 μm was calculated from the capacitance value at 1 MHz by using a mercury probe (product of Four Dimensions) and an LCR meter “HP4285A” (trade name; product of Yokogawa Hewlett Packard), resulting in 2.53. The Young's modulus of the film was measured using “NANO Indenter SA2” (trade name; product of MTS Nano instruments), resulting in 7.5 GPa. The stress in the insulating film was measured before and after heat treatment at 400° C. for 30 minutes by using “FLX-2320” (trade name; product of KLA-Tencor), resulting in a difference of 3% or less.

### Comparative Example 1

In a mixed solvent of 5.0 ml of cyclohexanone and 5.0 ml of anisole was dissolved 1.0 g of Polymer (A-1) by heating to prepare a coating solution. After filtration through a filter made of PTFE and having a pore size of 0.1 μm, the solution was spin-coated on a silicon wafer, followed by heating and drying at 15° C. for 60 seconds on a hot plate in a nitrogen gas stream. The film was then baked (aged by heating) for 60 mutes on a hot plate of 350 in a nitrogen gas stream. The relative dielectric constant of the resulting insulating film having a thickness of 0.5 μm was calculated from the capacitance value at 1 MHz by using a mercury probe (product of Four Dimensions) and an LCR meter “HP4285A” (trade name; product of Yokogawa Hewlett Packard), resulting in 2.53. The Young's modulus of the film was measured using “NANO Indenter SA2” (trade name; product of MTS Nano Instruments), resulting in 6.3 GPa. The stress in the insulating film was measured before and after heat treatment at 400° C. for 30 minutes by using “FLX-2320” (trade name; product of KLA-Tencor), resulting in a difference of about 10%.

### Example 3

In a mixed solvent of 5.0 ml of γ-butyrolactone and 5.0 ml of anisole was dissolved 1.0 g of Polymer (A-2) by heating to prepare a coating solution. After filtration through a filter made of PTFE and having a pore size of 0.1 μm, the solution was spin-coated on a silicon wafer, followed by heating and drying at 180° C. for 60 seconds on a hot plate in a nitrogen gas stream. The film was then aged by heating for 30 seconds while irradiating it with a 222-nm light at an energy corresponding to 10 mW/cm² by using a dielectric barrier discharge excimer lamp (product of Ushio Inc.) on a hot plate of 300° C. The resulting insulating film having a thickness of 0.5 μm had a relative dielectric constant of 2.54 and a Young's modulus of 6.4 GPa. The stress in the insulating film was measured before and after heat treatment at 400° C. for 60 minutes by using “FLX-2320” (trade name; product of KLA-Tencor), resulting in a difference of 3% or less.

### Example 4

In a mixed solvent of 50 ml of γ-butyrolactone and 5.0 ml of anisole was dissolved 1.0 g of Polymer (A-2) by heating. To the resulting solution was added 1-Hydroxycyclohexyl phenyl ketone (product of Aldrich) at a weight ratio, to the resulting solution, of 0.3 to prepare a coating solution. After filtration thug a filter made of PTFE and having a pore size of 0.1 μm, the solution was spin-coated on a silicon wafer, followed by heating and aging at 155° C. for 90 seconds on a hot plate in a nitrogen gas stream. Without changing the temperature, the film was aged by heating for 30 seconds while irradiating it with a 222-nm light at an energy corresponding to 10 mW/cm² by using a dielectric barrier discharge excimer lamp (Product of Ushio Inc). The resulting film having a thickness of 0.5 μm had a relative dielectric constant of 2.53 and a Young's modulus of 7.1 GPa. The stress in the insulating film was measured before and after heat treatment at 400° C. for 30 minutes by using “FLX-2320” (trade name product of KLA-Tencor), resulting in a difference of 5% or less.

### Comparative Example 2

In a mixed solvent of 5.01 of γ-butyrolactone and 5.0 ml of sole was dissolved 1.0 g of Polymer (A-2) by heating to prepare a coating solution. After filtration through a filter made of PTFE and having a pore size of 0.1 μm, the solution was spin-coated on a silicon wafer, followed by heating and drying at 180° C. for 60 seconds on a hot plate in a nitrogen gas stream. The film was heated and aged for 60 minutes on a hot plate of 4000 in a nitrogen gas stream. The resulting insulating film having a thickness of 0.5 μm had a relative dielectric constant of 2.56 and a Young's modulus of 5.8 GPa. The stress in the insulating film was measured before and after heat treatment at 400° C. for 30 minutes by using “FLX-2320” (trade name; product of KLA-Tencor) resulting in a difference of 15% or less.

### Synthesis Example 2

In accordance with the process described in Macromolecules, 5262, 5266(19911) 4,9-diethynyldiamantane was synthesized using diamantane as a raw material. Under a nitrogen gas stream, 10 g of 4,9-diethynyldiamantane, 50 ml of 1,3,5-triisopropylbenzene and 120 mg of Pd(PPh₃)₄ product of Aldrich) were stirred for 12 hours at a bulk temperature of 190° C. The reaction mixture was cooled to room temperature and then 300 ml of isopropyl alcohol was added thereto. A solid thus precipitated was collected by filtration and washed with methanol to yield 3.0 g of Polymer (B-1) having a mass average molecular weight of 20,000.

### Synthesis Example 5

In 10.0 ml of cyclohexanone was dissolved 1.0 g of Polymer (B-1) synthesized in Synthesis Example 2 to prepare a coating solution. After filtration through a filter made of PTFE and having a pore size of 0.2 μm, the solution was spin-coated on a silicon wafer, followed by heating and drying at 110° C. for 90 seconds. After treatment of the film at 250° C. for 90 seconds while irradiating it with a 254-nm light at a energy corresponding to 20 mW/cm² on a hot plate in a nitrogen gas stream, the resulting film was heated and dried at 350° C. for 60 seconds. The resulting insulating film having a thickness of 0.50 μm had a relative dielectric constant of 2.35 and a Young's modulus of 7.5 GPa. The stress in the insulating film was measured before and after heat treatment at 400° C. for 30 minutes by using “FLX-2320” (trade name; product of KLA-Tencor), resulting in a difference of 3% or less.

### Synthesis Example 6

In 10.0 ml of cyclohexanone was dissolved 1.0 g of Polymer (B-1) synthesized in Synthesis Example 2 to prepare a coating solution. After filtration through a filter made of PTFE and having a pore size of 0.2 μm, the solution was spin-coated on a silicon wafer, followed by heating and drying at 110° C. for 90 seconds. The resulting film was then heat treated at 350° C. for 30 seconds while irradiating it with electrons having an energy of 5 keV at 20 mC/cm² on a hot plate disposed in a vacuum chamber hag a vacuum degree less than 10⁶ Torr. The resulting insulating film having a thickness of 0.50 μm had a relative dielectric constant of 2.56 and a Young's modulus of 7.8 GPa. The stress in the insulating film was measured before and after heat treatment at 400° C. for 30 minutes by using “FLX-2320” (trade name; product of KLA-Tencor), resulting in a difference of 5% or less.

### Example 7

In 100 ml of cyclohexanone was dissolved 1.0 g of Polymer (B-1) synthesized in Synthesis Example 2. To the resulting mixture was added 1-Hydroxycyclohexyl phenyl ketone (product of Aldrich) at a weight ratio, relative to the solution, of 0.3 to prepare a coating solution. After filtration trough a filter made of PTFE a having a pore size of 0.2 μm, the solution was spin-coated on a silicon wafer, followed by heating and drying at 110° C. for 90 seconds. The resulting film was then heat treated at 300° C. for 20 seconds while irradiating it with electron having an energy of 5 keV at 20 mC/cm² on a hot plate disposed in a vacuum chamber having a vacuum degree less than 10⁶ Torr. The resulting insulating film having a thickness of 0.50 μm had a relative dielectric constant of 2.46 and a Young's modulus of 8.3 GPa. The stress in the insulating film was measured before and after heat treatment at 400° C. for 30 minutes by using “FLX-2320” (trade name; product of KLA-Tencor), resulting in a difference of 5% or less.

### Example 8

In 10.0 ml of cyclohexanone was dissolved 1.0 g of Polymer (B-1) synthesized in Synthesis Example 2. To the resulting solution was added Camphorquinone (product of Aldrich) at a mass ratio, relative to the solution, of 0.6 to prepare a coating solution. After filtration through a filter made of PTFE and having a pore size of 0.2 μm, the solution was spin-coated on a silicon wafer; followed by heating and drying at 110° C. for 90 seconds. The film was then treated at 200° C. for 30 seconds while irradiating it with a light having a wavelength around 525 nm at an intensity of 2 W/cm² by using 5 LEDs (product of Lumileds) on a hot plate disposed in a vacuum chamber having a vacuum degree less than 10⁶ Ton. The resulting insulating film having a thickness of 0.50 μm had a relative dielectric constant of 2.32 and a Young's modulus of 7.1 GPa. The stress in the insulating film was measured before and after heat treatment at 400° C. for 30 minutes by using “FLX-2320” (trade name; product of KLA-Tencor), resulting in a difference of 5% or less.

### Comparative Example 3

A similar solution to that of Example 5 was prepared. After filtration through a filter made of PTFE and having a pore size of 0.2 μm, the solution was spin-coated on a silicon wafer. The coating was heated and dried at 110° C. for 90 seconds and then at 250° C. for 90 seconds on a hot plate in a nitrogen gas stream. The film was then heated and aged for 60 minutes in an oven of 400° C. purged with nitrogen. The resulting insulating film having a thickness of 0.50 μm had a relative dielectric constant of 2.56 and a Young's modulus of 6.5 GPa. The stress in the insulating film was measured before and after heat treatment at 400° C. for 30 minutes by using “FLX-2320” (trade name; product of KLA-Tencor), resulting in a difference of 12%.

### Comparative Example 4

In 10.0 ml of cyclohexanone was dissolved 1.0 g of Polymer (B-2) (product of Sigma-Aldrich) to prepare a coating solution. After filtration through a filter made of PTFE and having a pore size of 0.2 μm, the solution was spin-coated on a silicon wafer. The coating was then treated at 350° C. for 30 seconds while irradiating it with electrons having an energy of 5 keV at 20 mC/cm² on a hot plate disposed in a vacuum chamber having a vacuum degree less than 10⁶ Torr. The resulting insulating film having a thickness of 0.50 μm had a relative dielectric constant of 2.7 and a Young's modulus of 4.5 GPa. The stress in the insulating film was measured before and after heat treatment at 400° C. for 30 minutes by using “FLX-2320” (trade name; product of KLA-Tencor), resulting in a difference of 5% or less.

### Comparative Example 5

In 10.0 ml of cyclohexanone was dissolved 1.0 g of Polymer (B-2) (product of Sigma-Aldrich). To the resulting solution was added 1-Hydroxycyclohexyl phenyl ketone (Aldrich) at a mass ratio, relative to the solution, of 0.3 to prepare a coating solution. After filtration through a filter made of PTFE and having a pore size of 0.2 μm, the solution was spin-coated on a silicon wafer. The coating was then treated at 350° C. for 30 seconds while irradiating it with electrons having an energy of 5 keV at 20 mC/cm² on a hot plate disposed in a vacuum chamber having a vacuum degree less than 10⁶ Torr. The resulting insulating 5 h having a thickness of 0.50 μm had a relative dielectric constant of 2.7 and a Young's modulus of 5 GPa. The stress in the insulating film was measured before and after heat treatment at 400° C. for 30 minutes by using “FLX-2320” (trade name; product of KLA-Tencor), resulting in a difference of 4% or less.

### Comparative Example 6

In 100 ml of cyclohexanone was dissolved 1.0 g of Polymer (B-2) (product of Sigma Aldrich) to prepare a coating solution. After filtration through a filter made of PTFE and having a pore size of 0.2 μm, the solution was spin-coated on a silicon wafer. The coating was heated and dried at 110° C. for 90 seconds and then at 250° C. for 60 seconds. The film was heated further for 60 minutes in an oven of 400° C. purged with nitrogen. The resulting insulating film having a thickness of 0.50 μm had a relative dielectric constant of 2.75 and a Young's modulus of 3.1 GPa. The stress in the insulating film was measured before and after heat treatment at 400° C. for 30 minutes by using “FLX-2320” (trade name; product of KLA-Tencor), resulting in a difference of 14%.

### Synthesis Example 3

In a nitrogen gas stream, 1 g of Exemplary compound (1-d) (vinyl-Polyhedral oligomeric silsesquioxane, product of Aldrich), 0.1 g of “Luperox 11” (trade name; product of Arkema Yoshitomi), and 100 g of 1,2-dichlorobonzene were stirred for 30 minutes at 140° C. After the reaction mixture was cooled to room temperature, it was added dropwise to 500 ml of stirred methanol. After stirring for further 1 hour, a solid matter was collected by filtration and dried to yield 0.51 g of Polymer (C-1). Analysis of the solid component by GPC resulted in MW=0.51 g and Mn=30,0000.

### Example 9

In 10.0 ml of PGMEA was dissolved 1.0 g of Polymer (C-1) synthesized in Synthesis Example 3. To the resulting solution was added 5 μl of “BYK306” (trade name; product of BYK Chemie) as a surfactant to prepare a coating solution. After filtration through a filter made of PTFE and having a pore size 0.2 μm, the solution was spin-coated on a silicon wafer, followed by heating and drying at 110° C. for 90 seconds. The film was then treated at 350° C. for 30 seconds while irradiating it with electrons having an energy of 5 keV a 20 mC/cm² on a hot plate disposed in a vacuum chamber having a vacuum degree less than 10⁶ Torr. The resulting insulating film having a thickness of 0.50 μm had a relative dielectric constant of 2.34 and Young's modulus of 8.5 Gpa. The stress in the insulating film was measured before and after heat treatment at 400° C. for 30 minutes by using “FLX-2320” (trade name; product of KLA-Tencor), resulting in a difference of 5%, or less.

### Comparative Example 7

In 10.0 ml of PGMEA was dissolved 1.0 g of Polymer (C-1) synthesized in Synthesis Example 3. To the resulting solution was added 5 μl of “BYK306” as a surfactant to prepare a coating solution. After filtration through a filter made of PTFE and having a pore size of 0.2 μm, the solution was spin-coated on a silicon wafer, followed by heating and drying at 110° C. for 90 seconds. The film was then treated at 350° C. for 60 minutes on a hot plate disposed in a vacuum chamber having a vacuum degree less than 10⁶ Torr. The resulting insulating film having a thickness of 0.50 μm had a relative dielectric constant of 2.38 and a Young's modulus of 5.2 Gpa. The stress in the insulating film was measured before and after heat treatment at 400° C. for 30 minutes by using “FLX-2320” (trade name; product of KLA-Tencor), result in a difference of 9%.

### Synthesis Example 4

In a nitrogen gas stream, 1 g of 4-Vinylphenyl-Cyclopentyl-POSS™ (product of Aldrich, Poss: trade mark of Aldrich), 0.1 g of “Luperox 11” (product of Arkema Yoshitomi), and 100 g of 1,2-dichlorobenzene were stirred for 30 minutes at 140° C. The reaction mixture was cooled to room temperature and then was added dropwise to 500 ml of stirred methanol. After stirring for further 1 hour, a solid matter was collected by filtration and dried to yield 0.51 g of Polymer (D-1).

### Example 10

In 10.0 ml of PGMEA was dissolved 1.0 g of Polymer (D-1) synthesized in Synthesis Example 4. To the resulting solution was added 5 μl of “BYK306” as a surfactant to prepare a coating solution. After filtration through a filter made of PTFE and having a pore size of 0.2 μm, the solution was spin-coated on a silicon wafer, followed by heating and drying at 110° C. for 90 seconds. The film was then treated at 350° C. for 30 seconds while irradiating it with electrons having an energy of 5 keV at 20 mC/cm² on a hot plate disposed in a vacuum chamber having a vacuum degree less than 10⁶ Torr. The resulting insulating film having a thickness of 0.50 μm had a relative dielectric constant of 2.31 and a Young's modulus of 8.1 Gpa. The stress in the insulating film was measured before and after heat treatment at 400° C. for 30 minutes by using “FLX-2320” (trade name; product of KLA-Tencor), resulting in a difference of 4% or less.

### Comparative Example 8

In 10.0 ml of PGMEA was dissolved 1.0 g of Polymer (D-1) synthesized in Synthesis Example 4. To the resulting solution was added 5 μl of “BYK306” as a surfactant to prepare a coating solution. After filtration through a filter made of PTFE and having a pore size of 0.2 m the solution was spin-coated on a silicon wafer followed by heating and drying at 110° C. for 90 seconds. The film was then treated at 350° C. for 60 minutes on a hot plate disposed in a vacuum chamber having a vacuum degree less than 10⁶ Torr. The resulting insulating film having a thickness of 0.50 μm had a relative dielectric constant of 2.4 and a Young's modulus of 4.3 Gpa. The stress in the insulating film was measured before and after heat treatment at 400° C. for 30 minutes by using “FLX-2320” (trade name; product of KLA-Tencor), resulting in a difference of 9%.

### Synthesis Example 5

To 361 g of ethyl acetate was added 1 g of Methacryl-Cyclopentyl-Polyhedral oligomeric silsesquioxane (product of Aldrich) and the resulting mixture was heated under reflux in a nitrogen gas stream. To the reaction mixture was added 0.1 g of “Luperox 11” (trade name; product of Arkema Yoshitomi), followed by heating under reflux for 7 hours. The reaction mixture was cooled to room temperature and then concentrated under reduced pressure to a liquid weight of 2.0 g. To the concentrate was added 20 ml of methanol. After stirring for one hour, a solid was collected by filtration and them, dried to yield 0.82 g of Polymer (E-1).

### Example 1

To 1.0 g of Polymer (E-1) obtained in Synthesis Example 5 was added 10 ml of PGMEA. The resulting mixture was stirred at 40° C. for 3 hours to prepare a uniform solution. To the resulting solution was added 5 μl of “BYK306” (trade name; product of BYK Chemie) as a surfactant to prepare a composition.

To the resulting composition was added 1-Hydroxycyclohexyl phenyl ketone (product of Aldrich) at a weight ratio, relative to the solution, of 0.1 to prepare a coating solution. After filtration through a filter made of PTFE and having a pore size of 0.2 μm, the solution was spin-coated on a silicon wafer, followed by heating and aging at 155° C. for 90 seconds on a hot plate in a nitrogen gas stream. At a temperature maintained at that temperature, the film was heated and aged for 30 seconds while irradiating it with a 222-nm light at an energy corresponding to 12 mW/cm² by using a dielectric barrier discharge excimer lamp (product of Ushio Inc.). The resulting insulating film having a thickness of 0.5 μm had a relative dielectric constant of 2.25 and a Young's modulus of 7.0 GPa. The stress in the insulating film was measured before and after heat treatment at 400° C. for 30 minutes by using “FLX-2320” (trade name; product of KLA-Tencor), resulting in a difference of 3% or less.

### Comparative Example 9

In 10.0 ml of PGMEA was dissolved 1.0 g of Polymer (E-1) synthesized in Synthesis Example 5. To the resulting solution was added 5 μl of “BYK306” as a surfactant to prepare a coating solution. After filtration through a filter made of PTFE and having a pore size of 0.2 μm, the solution was spin-coated on a silicon wafer, followed by heating and drying at 110° C. for 90 seconds. The film was then treated at 150° C. for 120 minutes on a hot plate disposed in a vacuum chamber having a vacuum degree less than 10⁶ Torr. The resulting insulating film having a thickness of 0.50 μm had a relative dielectric constant of 2.54 and a Young's modulus of 3.2 Gpa. The stress in the insulating film was measured before and after heat treatment at 400° C. for 30 minutes by using “FLX-2320” (trade name; product of KLA-Tencor), resulting in a difference of 15%.

### Synthesis Example 6

To 2166 g of ethyl acetate was added 3 g of cage-like silsesquioxane composed of 12 H₂C═CH—Si(O_{0.5})₃ units (product of Hybrid Plastics). In a nitrogen gas stream 570 μl of “Luperox 11” (trade name; product of Arkema Yoshitomi) was added and the resulting mixture was heated under reflux for 5 hours. After cooling to room temperature, the reaction was concentrated under reduced pressure to yield 3 g of a composition. The solid matter contained 3.4 mass % of the stain substance which had remained unreacted. GPC analysis of the solid matter resulted in MW=250,000 and Mn=40,0000. Calculation after elimination of the unreacted starting substance from the solid matter resulted in MW=314,000 and Mn=29,000.

### Example 12

To 1.0 g of the composition prepared in Synthesis Example 6 was added 10 ml of PGMEA. The resulting mixture was stirred at 40° C. for 3 hours to prepare a uniform solution. To the resulting uniform solution were added successively 5 μl of “BYK306” (product of BYK Chemie) as a surfactant and 0.5 g of 1-Hydroxycyclohexyl phenyl ketone product of Aldrich) to prepare a coating solution. After filtration through a filter made of PTFE and having a pore size of 0.2 μm, the solution was spin-coated on a silicon wafer, followed by heating and aging at 155° C. for 90 seconds on a hot plate in a nitrogen gas stream. The film was then treated at 350° C. for 40 seconds while irradiating it with electrons having an energy of 5 keV at 20 mC/cm² on a hot plate disposed in a vacuum chamber having a vacuum degree less than 10⁶ Torr. The resulting insulating film having a thickness of 0.5 μm had a relative dielectric constant of 2.29 and a Young's modulus of 8.1 Gpa. The stress in the insulating film was measured before and after heat treatment at 400° C. for 30 minutes by using “FLX-2320” (trade name; product of KLA-Tencor), resulting in a difference of 3% or less.

### Comparative Example 10

In 10.0 ml of PGMEA was dissolved 1.0 g of the composition prepared in Synthesis Example 6. To the resulting solution was added 5 μl of “BYK306” to prepare a coating solution. After filtration through a filter made of PTFE and having a pore size of 0.2 μm, the solution was spin-coated on a silicon wafer, followed by heating and drying at 110° C. for 90 seconds. The film was then treated at 150° C. for 120 minutes on a hot plate disposed in a vacuum chamber having a vacuum degree less than 10⁶ Torr. The resulting insulating film having a thickness of 0.50 μm had a relative dielectric constant of 2.65 and a Young's modulus of 2.8 Gpa. The stress in the insulating film was measured before and after heat treatment at 400° C. for 30 minutes by using “FLX-2320” (trade name; product of KLA-Tencor), resulting in a difference of 20%.

### Synthesis Example 7

In accordance with the process described in a document (Journal of Polymer Science: Part A: Polymer Chemistry, 30, 1747-1754 (1992)), 3,3′-diethynyl-11′-biadamantane was synthesized. Next, 2 g of the 3,3′-diethynyl-1,1′-biadamantane, 0.4 g of dicumyl peroxide (“Percumyl D”, trade name; product of NOF) and 10 ml of t-butylbenzene were stirred at a bulk temperature of 150° C. for 3 hours in a nitrogen gas stream to cause polymerization. The reaction mixture was cooled to room temperature and then added to 100 ml of methanol. A solid thus precipitated was collected by filtration and then, washed with methanol to yield 1.5 g of a polymer having a mass average molecular weight of about 12,000. The resulting polymer was then dissolved in cyclohexanone to prepare a composition having a concentration of 10 wt %.

### Example 13

A coating solution was prepared by adding 1-Hydroxycyclohexyl phenyl ketone (product of Aldrich) to the composition prepared in Synthesis Example 7 at weight ratio, relative to the solution, of 0.1. After filtration through a filter made of PTFE and having a pore size of 0.2 μm, the solution was spin-coated on a silicon wafer, followed by heating and aging at 155° C. for 90 seconds on a hot plate in a nitrogen gas stream. The film was then treated at 350° C. for 40 seconds while irradiating it with electrons having an energy of 5 keV at 20 mC/cm² on a hot plate disposed in a vacuum chamber having a vacuum degree less than 10⁶ Torr. The resulting insulation film having a thickness of 0.5 μm had a relative dielectric constant of 2.31 and a Young's modulus of 10.5 Gpa. The stress in the insulating film was measured before and after heat treatment at 400° C. for 30 minutes by using “FLX-2320” (trade name; product of KLA-Tencor), resulting in a difference of 3% or less.

### Example 14

A coating solution was prepared by adding 1-Hydroxycyclohexyl phenyl ketone (product of Aldrich) to the composition prepared in Synthesis Example 7 at a weight ratio, relative to the solution, of 0.1. After filtration through a filter made of PTFE and having a pore size of 0.2 μm, the solution was spin-coated on a silicon wafer, followed by heating and aging at 155° C. for 90 seconds on a hot plate in a nitrogen gas stream. At a temperature maintained at that temperature, the film was then heated and aged for 30 seconds while irradiating it with a 222-nm light at an energy corresponding to 12 mW/cm² by using a dielectric barrier discharge excimer lamp (product of Ushio Inc.). The resulting insulating film having a thickness of 0.5 μm had a relative dielectric constant of 0.29 and a Young's modulus of 9.8 Gpa. The stress in the insulating film was measured before and after heat treatment at 400° C. for 30 minutes by using “FLX-2320” (trade name; product of KLA-Tencor), resulting in a difference of 3% or less.

### Comparative Example 11

The composition prepared in Synthesis Example 7 was filtered through a filter made of PTFE and having a pore size of 0.2 μm and then spin-coated on a silicon wafer. The coating was heated at 150° C. for 60 seconds on a hot plate in a nitrogen gas stream, followed by baking for 60 minutes in oven of 400° C. purged with nitrogen to form a film. The relative dielectric constant of the resulting film was calculated from the capacitance value at 1 MHz by using a mercury probe (product of Four Dimensions) and an LCR meter “HP4285A” (trade name; product of Yokogawa Hewlett Packard), resulting in 2.40. The Young's modulus of the film was measured (at 25° C.) by using “NANO Indenter SA2” (trade name; product of MTS Nano Instruments), resulting in 9.0 MPa.

In the invention, a denser crosslinked structure is formed by using a low dielectric compound having a cage structure and exposing the compound to an electron beam or electromagnetic wave having a wavelength greater 200 nm, which results in advantages such as:

(1) an improvement in mechanical strength without increasing a dielectric constant.

(2) a reduction in an amount of functional groups (reduction of outgas) which will be released due to the breakage of a bond during heat treatment after film formation, and

(3) a reduction in linear expansion coefficient. The present invention therefore can provide an insulating film excellent in dielectric constant, mechanical strength and heat resistance.

The entire disclosure of each and every foreign patent application from which the benefit of foreign priority has been claimed in the present application is incorporated herein by reference, as if fully set forth.

What is claimed is:

1. A production method of an insulating film, comprising:
(1) a process of applying, onto a substrate, a film forming composition comprising a compound having a cage structure to form a film and then drying the film; and
(2) a process of irradiating the film with an electron beam or an electromagnetic wave having a wavelength greater than 200 nm.

2. The production method according to claim 1,
wherein the film forming composition comprises a compound having photosensitivity to an electron beam or an electromagnetic wave having a wavelength greater than 200 nm.

3. The production method according to claim 1,
wherein the compound having cage structure has a functional group having photosensitivity to an electron beam or an electromagnetic wave having a wavelength greater than 200 nm.

4. The production method according to claim 1,
wherein the compound having a cage structure is a polymer of a monomer having a cage structure.

5. The production method according to claim 4,
wherein the polymer is a polymer of a monomer having a cage structure and a carbon-carbon double bond or carbon-carbon triple bond.

6. The production method according to claim 1,
wherein the cage structure is selected from the group consisting of adamantane, biadamantane, diamantane, triamantane, and tetramantane.

7. The production method according to claim 4,
wherein the monomer having a cage structure is selected from the group consisting of compounds represented by the following formulas (I) to (VI): 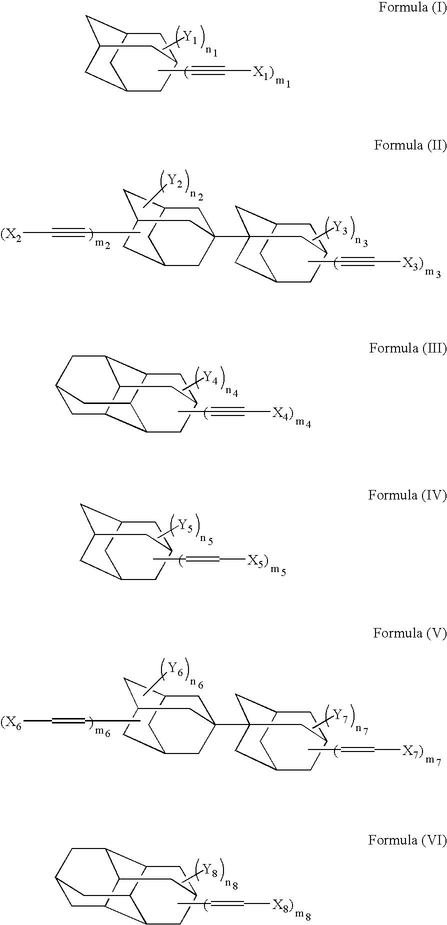
wherein X₁ to X₈ each independently represents a hydrogen atom, an alkyl group, an alkenyl group, an alkynyl group, an aryl group, a silyl group an acyl group an alkoxycarbonyl group or a carbamoyl group,
Y₁ to Y₈ each independently represents a halogen atom, an alkyl group, an aryl group or a silyl group,
m₁ and m₅ each independently represents an integer of from 1 to 16,
n₁ and n₅ each independently represents an integer of from 0 to 15,
m₂, m₃, m₆ and m₇ each independently represents an integer of from 1 to 15,
n₂, n₃, n₆ and n₇ each independently represents an integer of from 0 to 14,
m₄ and m₈ each independently represents an integer of from 1 to 20, and
n₄ and n₈ each independently represents an integer of from 0 to 19.

8. The production method according to claim 1,
wherein the compound having a cage structure comprises m pieces of RSi(O_{0.5})₃ units,
wherein m represents an integer of from 8 to 16,
each of Rs represents a non-hydrolyzable group, with the proviso that each of at least two Rs represents a group having a vinyl group or ethynyl group, and
each of the units is linked with other units by sharing the oxygen atoms to form the cage structure.

9. The production method according to claim 4,
wherein the monomer having a cage structure is a compound comprising m pieces of RSi(O_{0.5})₃ units,
wherein m represents an integer of from 8 to 16,
each of Rs represents a non-hydrolyzable group, with the proviso that each of at least two Rs represents a group having a vinyl group or ethynyl group, and
each of the units is linked with other units by sharing the oxygen atoms to form the cage structure.

10. An insulating film produced by the production method according to claim 1.

11. The insulating film according to claim 10,
wherein a rate of an internal stress change of the insulating film caused by heat treatment at 400° C. for 30 minutes is 10% or less.

12. An electronic device comprising the insulating film according to claim 10.
